(19) United States
(12) Patent Application Publication
(10) Pub. No.: US 2026/0361622 A1
(43) Pub. Date: Nov. 12, 2026

(54) WIRELESS COMMUNICATION SYSTEM HAVING KVI OR KPI FRAMEWORKS

(71) Applicant: QUALCOMM Incorporated, San Diego, CA (US)

(72) Inventors: Ahmed Farhan HANIF, Versailles (FR); Olufunmilola Omolade AWONIYI-OTERI, San Diego, CA (US); Gavin Bernard HORN, La Jolla, CA (US)

(21) Appl. No.: 19/204,138

(22) Filed: May 9, 2025

(51) Int. Cl. H04L 41/5009; H04B 17/309; H04L 41/16

(52) U.S. Cl. CPC H04L 41/5009; H04B 17/346; H04L 41/16

(57) ABSTRACT

KVI and KPI frameworks are described. A network device may obtain a configuration for functional parameters that is based on KVIs, for a set of key values for value criteria, and target values for KPIs, of communication network functionality. The configuration may be indicative entity KVIs and entity KPIs for the network device. Characteristics of the network device, jointly for the entity KVIs and the entity KPIs, may be indicative of meeting a condition for the value criteria. The network device may communicate, based on the configuration, and on the KVIs and the KPIs meeting the condition, with a different network device in association with an operation for the communication network functionality. A UE may receive, from the network device and based on the configuration communications for operation. The UE may provide, for the network device, collected data or feedback information for the KPIs or the KVIs.

### TECHNICAL FIELD

The present disclosure relates generally to communication systems, and more particularly, to wireless communications utilizing key performance indicators (KPIs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR, as an example, includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of later wireless communication technology, such as 6G, may be based on 5G NR. There exists a need for further improvements in 5G NR technology and future wireless communication technology, such as 6G. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. In aspect, the apparatus may be, or may comprise, a network device. The apparatus is configured to obtain a configuration for at least one functional parameter that is based on (i) a set of key value indicator (KVIs), for a set of key values that correspond to a set of value criteria associated with communication network functionality, and (ii) at least one target value for a set of key performance indicators (KPIs) associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. The apparatus is configured to communicate, based on the configuration and based on the set of entity KVIs and the set of entity KPIs meeting the condition, with a different network device in association with at least one operation for the communication network functionality.

In the aspect, the method includes obtaining a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. The method also includes communicating, based on the configuration and based on the set of entity KVIs and the set of entity KPIs meeting the condition, with a different network device in association with at least one operation for the communication network functionality.

In another aspect of the disclosure, a method, a computer-readable medium, and an apparatus are provided. In aspect, the apparatus may be, or may comprise, a user equipment (UE). The apparatus is configured to receive, from a network device and in accordance with a configuration for at least one functional parameter of the network device, at least one communication associated with an operation for communication network functionality, where the configuration is based on (i) a set of KVIs, for a set of key values that correspond to a set of value criteria associated with the communication network functionality, and (ii) at least one target value for a set of KPIs associated with the communication network functionality. The apparatus is configured to provide, for the network device and based on the at least one communication, one or more of collected data or feedback information associated with at least one of the set of KPIs or the set of KVIs.

In the aspect, the method includes receiving, from a network device and in accordance with a configuration for at least one functional parameter of the network device, at least one communication associated with an operation for communication network functionality, where the configuration is based on (i) a set of KVIs, for a set of key values that correspond to a set of value criteria associated with the communication network functionality, and (ii) at least one target value for a set of KPIs associated with the communication network functionality. The method also includes providing, for the network device and based on the at least one communication, one or more of collected data or feedback information associated with at least one of the set of KPIs or the set of KVIs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram for wireless communications, in accordance with various aspects of the present disclosure.

FIG. 5 is a diagram illustrating an example of a KVI and KPI framework, in accordance with various aspects of the present disclosure.

FIG. 6 is a diagram illustrating an example of a KVI and KPI framework, in accordance with various aspects of the present disclosure.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus and/or network entity.

FIG. 11 is a diagram illustrating an example of a hardware implementation for an example network entity.

FIG. 12 is a diagram illustrating an example of a hardware implementation for an example network entity.

### DETAILED DESCRIPTION

Wireless communication networks and systems may be utilized for communications between network nodes (e.g., base stations, gNBs, etc.), UEs, etc. Some wireless communication systems (such as a 5G system (or another type of system described herein, or advanced systems such as 5G derivatives, 6G, etc.)) may use KPIs to quantitively measure or track key performance for technical parameters and/or metrics during operation of network devices and services. As sustainability (e.g., in the contexts of environmental, social, and economic sustainability) may emerge as an important factor in many enterprises, advanced systems such as 5G derivatives may incorporate such sustainability in the future, and 6G technology, across its use cases, may benefit from ground-up designs that incorporate sustainability goals (e.g., in the contexts of environmental, social, and economic sustainability) to enable energy efficiency, cost efficiency, and/or the like.

However, sustainability, in the contexts of environmental, social, and economic sustainability, for wireless communication systems (such as a 5G system (or another type of system described herein, or advanced systems such as 5G derivatives, 6G, etc.)) may have relatively few considerations or expectations in example use cases. For instance, minimizations for usage footprints (e.g., negative impacts) of wireless communication systems, including future generations such as 6G, etc., may enable positive impacts and risk avoidance in other sectors induced from various use cases. There is a need for a framework that may be used to analyze a given use case with respect to its key values (KVs), KVIs, and KPIs to ensure that a use case is able to satisfy respective targets on KVIs and KPIs during its usage lifetime.

Various aspects relate generally to wireless communication systems on communication networks. Some aspects more specifically relate to communication network functionality with KVI and KPI frameworks. In some examples, a network device (e.g., a UE, a gNB, a core network function/entity, and/or the like) may obtain a configuration for at least one functional parameter thereof. The configuration may be based on (i) a set of KVIs, for a set of key values that correspond to a set of value criteria associated with communication network functionality, and on (ii) at least one target value for a set of KPIs associated with the communication network functionality. That is, aspects account for a framework that considers criteria for both KVIs and KPIs. The configuration may be indicative of a set of entity KVIs, for a network device, associated with the set of KVIs and of a set of entity KPIs, for the network device, associated with the set of KPIs. Characteristics of the network device, e.g., jointly, e.g., for both, the set of entity KVIs and the set of entity KPIs, may be indicative of meeting a condition associated with the set of value criteria for the communication network functionality, and such a condition may be based on sustainability, e.g., in the contexts of environmental, social, and economic sustainability. The network device may thus be configured to communicate, based on the configuration and based on the set of entity KVIs and the set of entity KPIs meeting the condition, with other network devices in association with at least one operation for the communication network functionality. Additionally, a UE, a gNB, etc., may receive, from a network device and in accordance with such a configuration for at least one functional parameter of the network device, at least one communication associated with an operation for the communication network functionality. The UE, gNB, etc., may provide collected data and/or feedback information associated with at least one of the set of KPIs or the set of KVIs for the network device.

Particular aspects of the subject matter described in this disclosure can be implemented to realize one or more of the following potential advantages. In some examples, by providing KVI and KPI frameworks for analyzing given use cases with respect to their KVs, KVIs, and KPIs, the described techniques can be used to enable continued satisfaction for respective targets on KVIs and KPIs in use cases to promote, improve, and maintain sustainability goals and performance together, e.g., in the contexts of environmental, social, and economic sustainability. In some examples, by providing collected data and/or feedback information associated with KVIs/KPIs associated with a network device, the described techniques can be used to enable continued tracking and improvements for sustainability considerations, e.g., in the contexts of environmental, social, and economic sustainability.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, etc., may be arranged in multiple manners with various components or constituent parts. In such a wireless communication system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

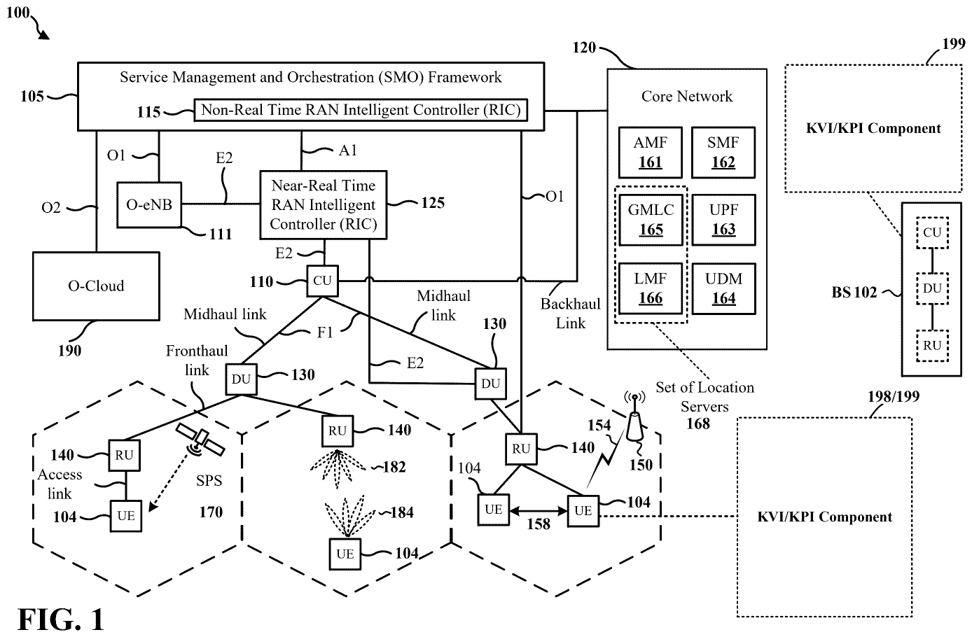

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRA CH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate A I/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ A I/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Y×MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. As an example, to illustrate the concept, in 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NRE-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a KVI/KPI component 198 (e.g., “the component 198”) that may be configured to receive, from a network device and in accordance with a configuration for at least one functional parameter of the network device, at least one communication associated with an operation for communication network functionality, where the configuration is based on (i) a set of KVIs, for a set of key values that correspond to a set of value criteria associated with the communication network functionality, and (ii) at least one target value for a set of KPIs associated with the communication network functionality. The component 198 may also be configured to provide, for the network device and based on the at least one communication, one or more of collected data or feedback information associated with at least one of the set of KPIs or the set of KVIs. In certain aspects, the UE 104, the base station 102, an entity of the core network 120, a network device shown in FIG. 1, and/or the like may have a KVI/KPI component 199 (e.g., “the component 199”) that may be configured to obtain a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. The component 199 may be configured to communicate, based on the configuration and based on the set of entity KVIs and the set of entity KPIs meeting the condition, with a different network device in association with at least one operation for the communication network functionality. The component 199 may also be configured to adjust the at least one functional parameter of the network device based on at least one of the set of KVIs or the set of KPIs failing to meet the condition. Accordingly, aspects enable continued satisfaction for respective targets on KVIs and KPIs in use cases to promote, improve, and maintain sustainability, e.g., in the contexts of environmental, social, and economic sustainability, and performance together by providing KVI and KPI frameworks for analyzing given use cases with respect to their KVs, KVIs, and KPIs, and also enable continued tracking and improvements for sustainability considerations, e.g., in the contexts of environmental, social, and economic sustainability, by providing collected data and/or feedback information associated with KVIs/KPIs associated with a network device.

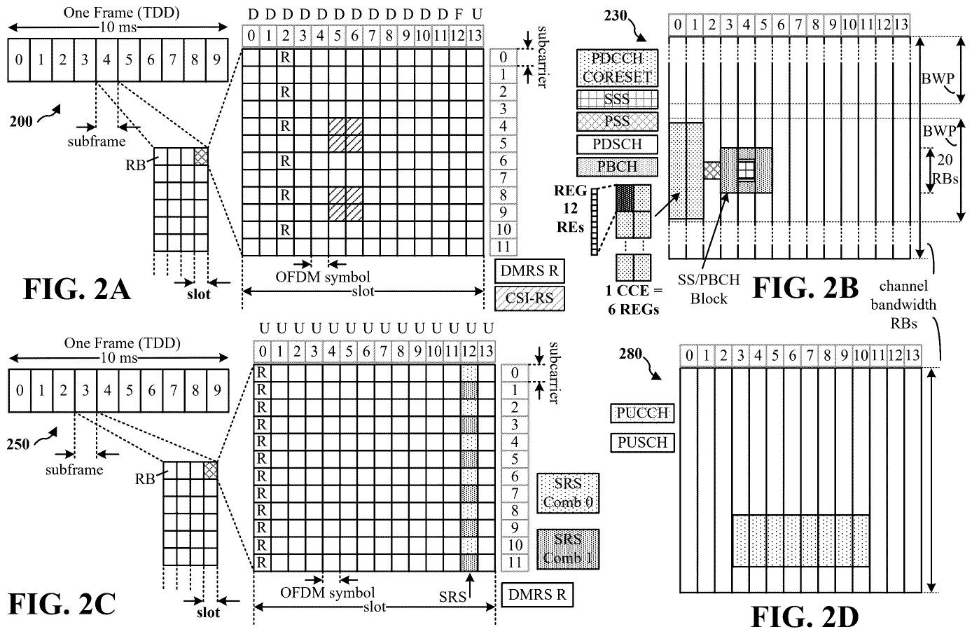

FIG. 2A is a diagram 200 illustrating an example of a first subframe within a 5G NR frame structure. The examples in FIGS. 2A-2D, illustrate aspects of a frame structure based on 5G NR to illustrate the concept of time and frequency resources based on a frame structure. Similar aspects may be used in connection with other technology, such as 6G, for example. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

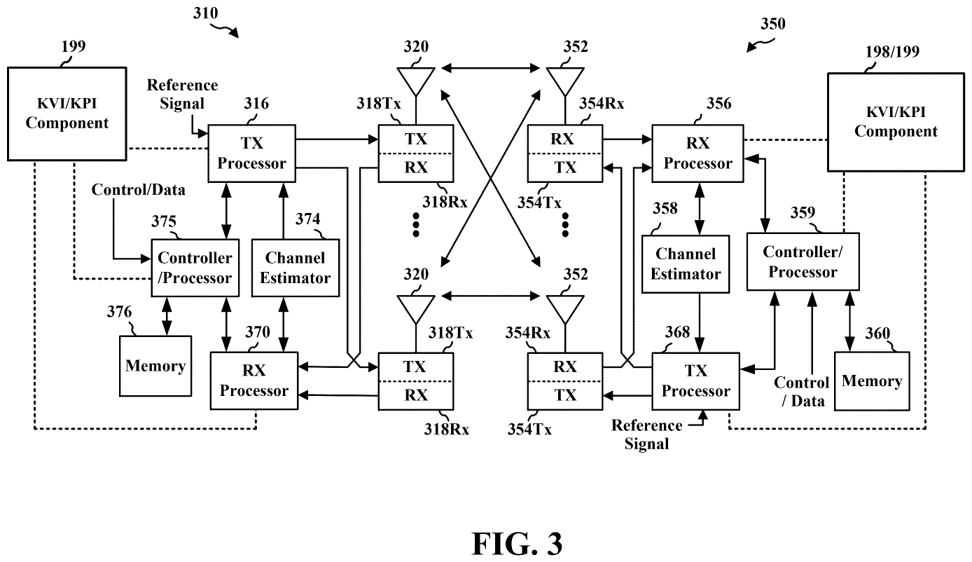

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198/the component 199 of FIG. 1.

At least one of the TX processor 316, the RX processor 370, and the controller/processor 375 may be configured to perform aspects in connection with the component 199 of FIG. 1.

Some wireless communication systems (such as a 5G system (or another type of system described herein, or advanced systems such as 5G derivatives, 6G, etc.)) may use KPIs to quantitively measure or track key performance for technical parameters and/or metrics during operation of network devices and services. Y et, sustainability in the contexts of environmental, social, and economic sustainability, for wireless communication systems (such as a 5G system (or another type of system described herein, or advanced systems such as 5G derivatives, 6G, etc.)) may have relatively few considerations or expectations in example use cases. For instance, minimizations for usage footprints (e.g., negative impacts) of wireless communication systems, including future generations such as 6G, etc., may enable positive impacts and risk avoidance in other sectors induced from various use cases. There is a need for a framework that may be used to analyze a given use case with respect to its KVs, KVIs, and KPIs to ensure that a use case is able to satisfy respective targets on KVIs and KPIs during its usage lifetime.

In aspects, and in the context of wireless communication systems such as 5G NR, and future generations such as 6G, etc., key values and KVIs may represent values that affect a wide range of users. KVIs may be a tool to demonstrate the value impact of technology and how societal challenges are addressed. The impact to wireless communication systems may be assessed and addressed with KVIs, according to aspects herein. In aspects, KVIs may be quantitative or qualitative indicators for gauging effects on benefits or values as outcomes. One purpose of KVIs may be to gauge the results from execution of a use case in terms of economic, social, and/or ecological benefits (gains) or detriments (losses). KVIs may be measurable indicators, either on a qualitative scale (e.g., good-bad, etc.), or on a quantitative scale (e.g., high-low, etc.), and may be referred to within the scope of a specific use case and scenario. In some aspects, e.g., in 6G contexts by way of example and not limitation, key performances may complement performance-related capabilities, and may be assessed with KPIs. KPIs may be referred to as quantitative results of gauging performance.

In aspects, a scenario may be a context where a technology will be used (e.g., who and where) and a vision of a future desired state. Use cases may be contained and/or included in a scenario. A use case, e.g., within the scenario context, may be a usage of the technology for a specific outcome, with details on deployment and user actions, e.g., a functional definition with parameters that can be measured by KPIs. Parameters may be functionalities or performance parameters as measured in KPIs for the implementation of a use case. The term “value as criteria/a goal” may refer to high-level human values as goals, e.g., such as the United Nations Sustainable Development Goals (SDGs) or their subsets. Values as criteria/goals may not be key values, in aspects. In some aspects, a value as outcome may be a key value. Technical enablers may be the technology components, devices, and/or functions utilized to deliver the key values for a use case, e.g., the technical solution. A key value (KV) may represent the intended positive impact of the technology on high-level human and/or planetary goals (e.g. such as the UN SDGs). A vey value may regroup (i) the impact from the use of the technology (use case usage, e.g., indirect impact) and (ii) the impact from the deployment of the technology (e.g., direct impact). Key values may be values as outcomes (e.g., being an outcome of a use case application on a communication system, e.g., a 5G or a 6G system). A KVI may be a qualitative or quantitative indicator for measuring a key value. A KVI may (may desirably and/or to enable implementation for a technical enabler) reach a certain target value (which may be defined and/or configured). In aspects, rather than a target value, a relative value with regard to a baseline (which may be defined and/or configured) may also be used. In some aspects, there may be two types of KVIs: use case KVIs and enabler KVIs. A use case KVI (e.g., a benefit) may be referred to as an implementation KVI, and may be a quantitative or qualitative indicator resulting as a direct impact of a use case (e.g., an application) on the key value. An enabler KVI (e.g., a cost) may be a quantitative or qualitative indicator for measuring the impact of the technical enabler on the key value. A key performance may be a technical value, such as a performance, for a 5G/6G system, etc. (e.g., for network coverage, SNR, network throughput, latency, and/or the like). In aspects, KPIs may generally be derived by standardization organisations (e.g., 3GPP, among other examples), but additional KPIs may complete them, coming from the KVI analysis process, as described herein. A KPI may be a quantitative indicator for measuring the technical key performance, such as where use cases are utilized to derive technical parameters, e.g., KPIs, such as end-to-end (E2E) service level KPIs and component level KPIs, by way of example.

In some examples of wireless communication systems and networks, a technology enabler selection may be based on service KPI requirements, without considerations for KVIs. In other examples, determinations of enablers may be based on KVIs, without considerations for KPIs, which may in turn produce relevant KPIs. Aspects herein improve upon such examples and provide for technical enabler selections based on both KVIs and KPIs. Without a clearly defined relationship between KVIs and technology, using KVIs for the selection of a specific technology may lead to an infeasible/cumbersome solution. Likewise, KPIs alone, without the knowledge of KVIs, may lead to a choice of a technology that does not deliver on the intended value of the use case. Accordingly, aspects herein provide technology enabler selections based jointly on both KVI and KPI metrics to enable improvements over other examples.

Aspects herein provide for KVI and KPI frameworks. Key values and KVIs are provided, which may be utilized to determine aspects for sustainability, e.g., in the contexts of environmental, social, and economic sustainability. Aspects provide for joint determinations of KPIs and KVIs, including determinations for meeting value targets with both KPIs and KVIs considered together and both KPIs and KVIs considered separately. Aspects may enable continued satisfaction for respective targets on KVIs and KPIs in use cases to promote, improve, and maintain sustainability, e.g., in the contexts of environmental, social, and economic sustainability, and performance together by providing KVI and KPI frameworks for analyzing given use cases with respect to their KVs, KVIs, and KPIs, and may also enable continued tracking and improvements for sustainability considerations, e.g., in the contexts of environmental, social, and economic sustainability, by providing collected data and/or feedback information associated with KVIs/KPIs associated with a network device.

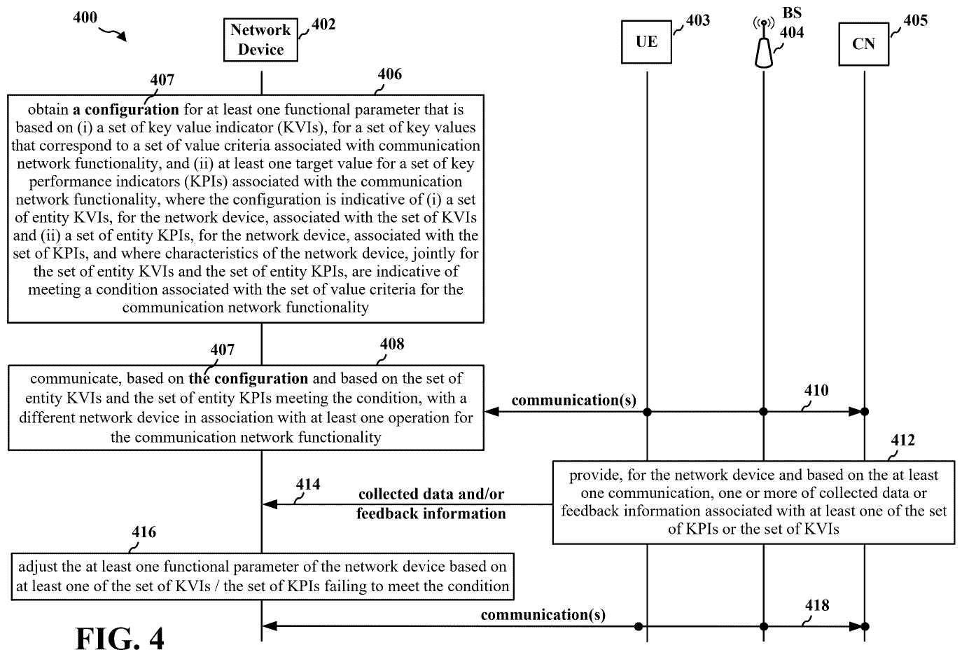

FIG. 4 is a call flow diagram 400 for wireless communications, in various aspects. Call flow diagram 400 illustrates a KVI and KPI framework for a network device 402 that is configured (e.g., in association with KVIs/KPIs) for communication with another network device (a UE 403, a base station 404, an entity/function of the core network 405, and/or the like), e.g., for transmission of communications and reception of collected data/feedback information. In aspects, the network device 402 may be a UE, a base station/gNB, a TRP, an AP, a reflecting intelligent surface (RIS), etc. While shown separately from the core network 405 for description and illustrative clarity, the network device 402 may be an AMF, an LMF, an SMF, and/or the like within the core network 405, including a sustainability management entity or a sustainability management function that may be associated with the core network 405. Aspects for a base station, such as a gNB or other type of base station, by way of example, may be performed in aggregated form and/or by one or more components thereof in disaggregated form.

The network device 402 may be configured to obtain (at 406) a configuration 407 for at least one functional parameter that is based on (i) a set of KVIs, for a set of key values that correspond to a set of value criteria associated with communication network functionality, and (ii) at least one target value for a set of KPIs associated with the communication network functionality. In aspects, the configuration 407 may be indicative of (i) a set of entity KVIs (e.g., enabler KVIs), for the network device 402, associated with the set of KVIs and (ii) a set of entity KPIs (e.g., enabler KPIs), for the network device 402, associated with the set of KPIs. Characteristics of the network device 402, jointly for the set of entity KVIs and the set of entity KPIs (e.g., as determined both together or both separately), may be indicative of meeting a condition associated with the set of value criteria for the communication network functionality. In some aspects, the communication network functionality may include non-communicative operations at the network device 402. Non communicative operations may include, without limitation, use case level statistics associated with a specific use case (e.g., engagement, effectiveness, attention to content, etc.), and/or the like, when such information is available to the network device 402. In aspects, the set of key values may include at least one of a set of economic criteria, a set of social criteria, a set of environmental criteria, and/or the like, and the set of KVIs may be indicative of quantified or qualified effects that correspond to the set of key values. In such aspects, the set of KVIs may include at least one implementation KVI associated with an improvement effect for the set of key values. In aspects, the set of KPIs may include at least one measurement of performance for a communication network. In such aspects, the at least one measurement may be associated with one or more of a network coverage, a signal-to-noise ratio (SNR), a signal to interference and noise ratio (SINR), a mobility metric, a power consumption, a network throughput, a network latency, and/or the like.

The network device 402, to obtain the configuration 407, may be configured to receive the configuration 407 in accordance with a selection of the network device 402, from a set of network devices, that is based on the network device 402 meeting the condition.

The network device 402 may be configured to communicate (at 408), based on the configuration 407 and based on the set of entity KVIs and the set of entity KPIs meeting the condition, with a different network device (e.g., the UE 403, the base station 404, the entity/function of the core network 405, and/or the like) in association with at least one operation for the communication network functionality. The network device 402, to communicate (at 408) with the different network device in association with the communication network functionality, may be configured to communicate over at least one of a core network, a RAN, a LAN, or a point-to-point wireless connection. To communicate (at 408) with the different network device in association with the communication network functionality, the network device may be configured to communicate (at 408) based on a software application executed at a UE (e.g., the UE 403). The software application may be associated with the set of key values, in aspects, and to communicate with the different network device in association with the communication network functionality, the network device 402 may be configured to receive, from the UE 403, one or more of collected data or feedback information 414 associated with at least one of the set of KPIs or the set of KVIs.

The UE 403 may be configured to receive, from the network device 402 and in accordance with a configuration 407 for at least one functional parameter of the network device 402, at least one communication 410 associated with an operation for communication network functionality, where the configuration 407 is based on (i) a set of key value indicator (KVIs), for a set of key values that correspond to a set of value criteria associated with the communication network functionality, and (ii) at least one target value for a set of key performance indicators (KPIs) associated with the communication network functionality.

The UE 403 may be configured to provide (at 412), and the network device 402 may be configured to receive, based on the at least one communication 410, one or more of collected data or feedback information 414 associated with at least one of the set of KPIs or the set of KVIs. In aspects, to receive one or more of the collected data or feedback information 414, the network device 402 may be configured to receive one or more of the collected data or feedback information 414 based on at least one of a reporting periodicity or a reporting content configuration. The UE 403, to receive the at least one communication 410 and/or to provide one or more of the collected data or feedback information 414, may be configured to communicate over at least one of a core network, a RAN, a LAN, or a point-to-point wireless connection. The at least one communication 410 may be indicative of at least one of a reporting periodicity or a reporting content configuration associated with one or more of the collected data or feedback information 414. In aspects, one or more of the collected data or feedback information 414 may correspond to a software application, executed at the UE 403, that is associated with the set of key values. In aspects, one or more of the collected data or feedback information 414 may be associated with a set of values for at least one of the set of KPIs or the set of KVIs.

The UE 403, to provide (at 412) for the network device 402 and based on the at least one communication 410, one or more of the collected data or feedback information 414, may be configured to provide (at 412) one or more of the collected data or feedback information 414 based on at least one of the reporting periodicity or the reporting content configuration.

The network device 402 may be configured to adjust (at 416) the at least one functional parameter of the network device 402 based on at least one of the set of KVIs or the set of KPIs failing to meet the condition. In aspects, to adjust the at least one functional parameter, the network device 402 may be configured to adjust the at least one functional parameter prior to the at least one operation and/or may be configured to communicate (e.g., at 408) as a portion of the at least one operation, with at least one of a UE (e.g., the UE 403) or a base station (e.g., the base station 404), and to receive, from at least one of the UE (e.g., the UE 403) or the base station (e.g., the base station 404), one or more of collected data or feedback information 414 associated with at least one of the set of KPIs or the set of KVIs after the prior adjustment. In aspects, the one or more of collected data or feedback information 414 associated with at least one of the set of KPIs or the set of KVIs may be indicative of the network device 402 meeting, or failing to meet, the condition. In aspects, the condition may comprise a KPI condition and a KVI condition, and the network device 402, to adjust (at 416) the at least one functional parameter, may be configured to adjust (at 416) the at least one functional parameter, based on at least one of (i) a set of iterations or (ii) a machine learning (AI)/artificial intelligence (ML) (AI/ML) model associated with KVI and KPI training sets, for changes to one or more of the set of KVIs or the set of KPIs until separately the set of KVIs meets the KVI condition and the set of KPIs meet the KPI condition.

In aspects, to adjust (at 416) the at least one functional parameter, the network device 402 may be configured to adjust (at 416) the at least one functional parameter, based on at least one of (i) a set of iterations or (ii) a machine learning (AI)/artificial intelligence (ML) (AI/ML) model associated with KVI and KPI training sets, for changes to one or more of the set of KVIs or the set of KPIs until the set of KVIs and the set of KPIs jointly meet the condition together. The network device 402, jointly for the set of entity KVIs and the set of entity KPIs, may meet the condition associated with the set of value criteria for the communication network functionality based on a condition determination of both of the set of entity KVIs and the set of entity KPIs together. In aspects, the condition may comprise a KPI condition and a KVI condition, and the network device 402 may meet the KVI condition for the set of entity KVIs and separately may meet the KPI condition for the set of entity KPIs, in association with the set of value criteria for the communication network functionality based on a condition determination of both of the set of entity KVIs and the set of entity KPIs separately.

In aspects, the network device 402 may be configured communicate, subsequent to the adjustment (at 416) an additional communication(s) 418. The additional communication(s) 418 may thus be based on the adjustment (at 416) for a functional parameter(s) (e.g., an adjusted functional parameter(s)) of the network device 402 based on at least one of the set of KVIs/the set of KPIs failing to meet the condition and a subsequent adjustment (at 416) therefor to maintain KVIs/KPIs and/or sustainability, e.g., in the contexts of environmental, social, and economic sustainability.

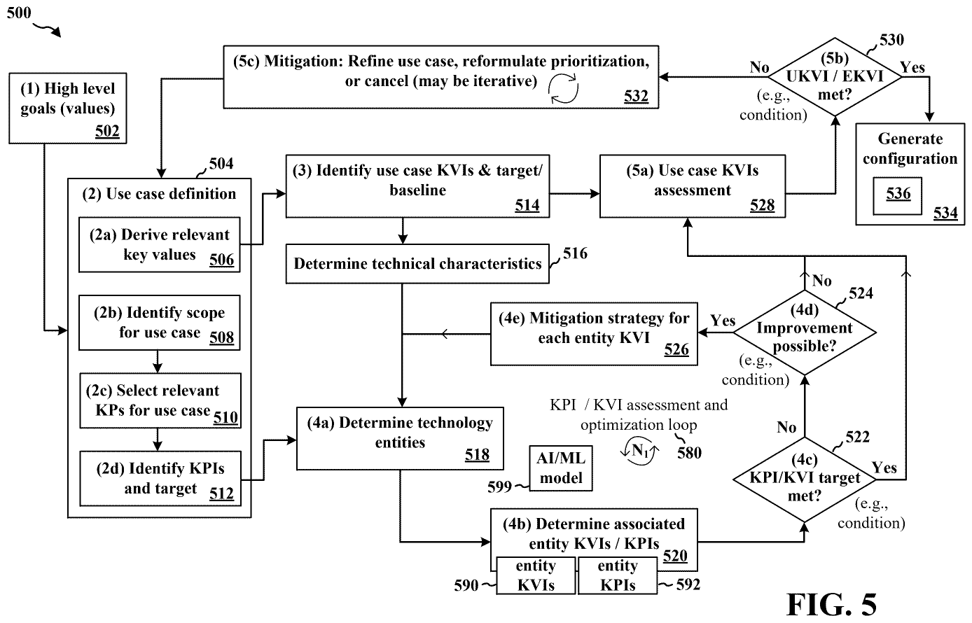

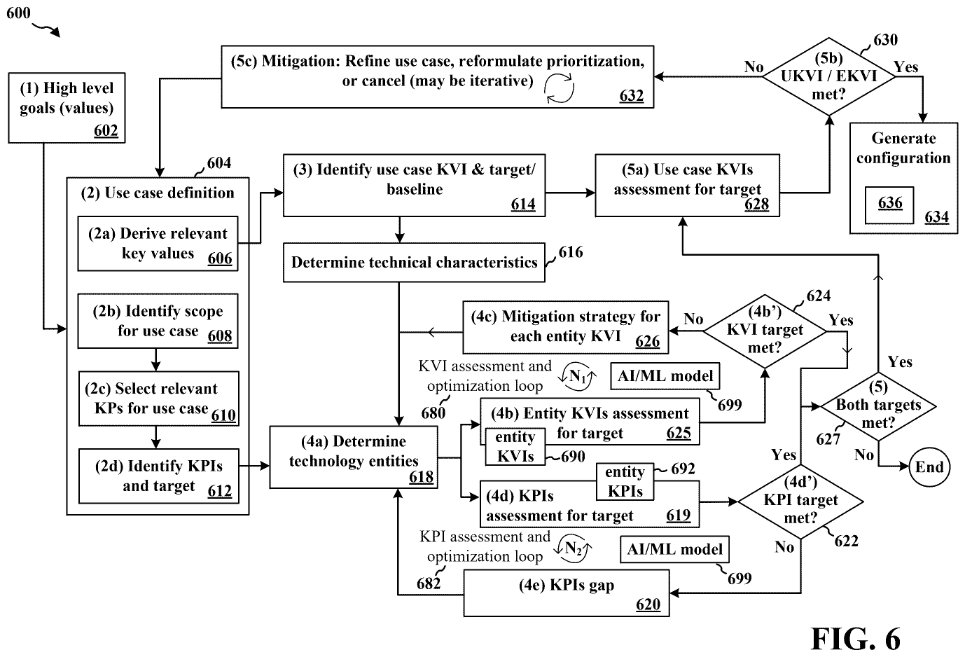

Referring now to FIGS. 5, 6, aspects for KVI and KPI frameworks may include starting with value as a goal, and choosing a use case to support the value. Aspects include selecting the key value that the use case enables, and identifying use case KVIs (e.g., implementation KVIs) and a corresponding target/baseline. Aspects also include determining the technology enablers (e.g., network devices), the enabler KVIs (e.g., entity KVIs), the target KPIs, and the performance targets, as well as mitigation strategies for each enabler KVI (e.g., if further improvement in enabler KVIs is possible, aspects may provide for looping back to determining the technology enablers, the enabler KVIs, the target KPIs, and the performance targets; otherwise aspects may proceed to next aspects. If an enabler KVI is within the target of the use case KVIs, then a configuration for the enabler may be generated and the flow may stop; otherwise the use case may be refined, or may be canceled (e.g., and started over with a new value as the goal.

FIG. 5 is a diagram 500 illustrating an example of a KVI and KPI framework, in various aspects. Diagram 500 may be an aspect of the call flow diagram 400 in FIG. 4. In diagram 500, technology enabler selection and configuration (e.g., for a network device, such as the network device 402 in FIG. 4) may be based on KVI and KPI targets defined in the use case definition herein. Diagram 500 illustrates a KVI/KPI assessment and optimization loop 580 (e.g., for a configurable N₁ number of iterations), for improving the achievable KVI and KPI, that is performed jointly for both KVIs and KPIs.

As noted above, the example framework in diagram 500 may start with a value as the goal (at 502). As one example, the goal may be one of the United Nations SDGs, such as but not limited to, climate action, digital inclusion, reduced inequalities, personal health and protection from harm, access to quality education, privacy and confidentiality, biodiversity, etc. For instance, the goal (at 502) may be to enable learning and improve comprehension (e.g., via digital inclusion, access to quality education, etc.).

Regarding goals, use case/implementation definitions may take into account the technical goals, business goals, human and planetary goals, etc., such as to enable learning and improve comprehension, as noted for an example above. At 504, a use case may be defined, such as within a scenario/context to define specific outcomes with narrower focus on location, population, or activity, and including technology deployment and user action details. In aspects, this may include developing a vision of improvement from a current state of matters. Continuing the example, this may include enabling learning and improving comprehension using Mixed Reality (MR) collaboration and/or immersive platforms and services.

At 506, a relevant value as a goal for the given use case may be selected (which may include a relevant key values being derived), and at 508, a relevant key value as outcome may be derived and/or a use case scope may be identified (e.g., identify the scope for a given use case). Continuing with the example above, for sensations, students may benefit from being able to touch, see, manipulate models. In aspects, relevant key values (e.g., values as outcomes) may be determined at 506, and for each relevant goal, the positive and negative impact(s) of the use case and technology/enabler on the high-level human and planetary goals may be formulated (e.g., these may be key values (or value as outcomes)). A positive impact of a use case and a technology use may be maximized, while negative impacts may be minimized. In aspects, key values may be identified in the three sustainability pillars, e.g., in association with use case (e.g., economic sustainability (benefit: increased level of education/training for the population, impact: cost of extended reality (XR) platforms for the enterprises/universities); social sustainability (benefit: enhanced inclusion due to enhanced ability to interact with local and remote students/teachers, impact: digital divide), and environmental sustainability (benefit: reduced travel as a result of remote work/study, impact: carbon dioxide footprint associated with the running of services and devices)).

The technical scope/parameters (e.g., KPIs) may be defined and analyzed. Functional service parameters for given use case may be identified (e.g., for key performances) at 510 (e.g., select relevant key performances for the given use case). For example, in an immersive learning use case, a virtual classroom may be identified for creating an engaging and immersive virtual learning environment. KPIs and their targets for the given UC may be identified and selected at 512, such as for network throughputs, E2E latency, network coverage, etc. (e.g., identify KPIs and their target).

At 514, use case KVI and target value may be determined. Use case/implementation KVIs may be linked to positive and negative impact(s) of the use case (e.g., the positive and negative impact of the technology use may be part of the enabler KVIs). For each of the key values (from 506), measurable (e.g., qualitatively or quantitatively) indicators may be found as the KVIs. For each of the KVIs, a target may be set as an absolute target value or a relative target value (e.g., a change) with respect to a baseline. The baselines for relative targets (e.g. a current matter status) may be determined. Continuing with the example above, such change may be associated with improved engagement measured as, for example, a. number of attendees, hours of attendance/participations of audience based on questions asked, interactions with three-dimensional models, etc., an average retention time, online engagement, improved test scores, improved comprehension, and/or the like. From the use case KVIs and target/base line, technical characteristics for enablers may be determined (at 516).

At 518, aspects provide for a determination of the technology enablers, enabler/entity KVIs, targets KPIs, and performance targets, e.g., as technical realization. The technology components/enablers that impact key values and the overall use case feasibility may be determined. As one case, for each technology enabler, associated indicators (e.g., the enabler KVIs) with respect to the three sustainability pillars may be determined. In continuation of the example from above, XR may be determined over 6G, by way of example, for determining the technology enablers. In such a context, for XR over 6G, in the example there may be economic sustainability (benefit: enabling the immersion and helping with skill building, impact: cost of additional hardware for XR and high spectrum usage); social sustainability (benefit: improving accessibility to content, impact: greater dependence on technology), and environmental sustainability (benefit: lowering the carbon dioxide footprint because of reduced travel, impact: marginal for transportation-carbon dioxide footprint associated with the running of services and devices). At 520, associated ones of the enabler KVIs 590 and enabler KPIs 592 may be determined, e.g., the KVIs and KPIs may be assessed for the selected technology enabler (e.g., at 518). At 522, a condition may be determined, e.g., “are the KPIs/KVIs fulfilling or meeting the target?” If the enabler KVIs 590/the enabler KPIs 592 are above or meeting the target, the framework may then proceed to 528; otherwise, to 524. At 524, a condition may be determined as to whether further improvement is possible for the enabler KVIs 590 and/or the enabler KPIs 592. If further improvement in the enabler KVIs 590 and/or the enabler KPIs 592, is possible, a mitigation strategy for each enabler KVIs 590 may be implemented at 526, and the gap between the achieved KVI and the desired KVI targets may be calculated. The enabler parameters may be modified or adjusted such that the KVIs are in range. This KPI/KVI assessment and optimization loop 580 may continue for a number N₁ number of iterations. During a first performance of the determination (at 520) and/or the mitigation strategy for each enabler KVIs 590 that is implemented at 526, and/or during subsequent iterations thereof for adjustments, such determinations and/or mitigation in the assessment and optimization loop 580 for adjustments may also be based on an AI/ML model 599. In aspects, the AI/ML model 599 may be associated with (e.g., trained on) KVI and KPI training sets that include one or more of current or prior KVIs and/or KPIs for the selected technology enabler, and/or may include one or more of current or prior KVIs and/or KPIs for a different technology enabler(s).

A mitigation strategy for each enabler KVI is also provided, in aspects, and may utilize the enabler KVIs 590 and the enabler KPIs 592, described above, for use case KVI assessment at 528. The use case KVIs identified at 514 may also be utilized at 528 for the assessment. In aspects, all KVIs and KPIs may be jointly assessed, together, at this stage. At 530, a condition may be determined as to whether the use case KVI and the enabler KVI are sufficient/acceptable. If the use case KVI and the enabler KVI meet/are above the target, then a configuration 536 for a network device may be generated at 534. Accordingly, the configuration 536 may be for at least one functional parameter and may be based on (i) a set of KVIs, for a set of key values that correspond to a set of value criteria associated with communication network functionality, and (ii) at least one target value for a set of KPIs associated with the communication network functionality. In aspects, the configuration 536 may be indicative of (i) a set of entity KVIs (e.g., enabler KVIs 590), for the network device, associated with the set of KVIs and (ii) a set of entity KPIs (e.g., enabler KPIs 592), for the network device, associated with the set of KPIs at 512. Characteristics of the network device, jointly for the set of entity KVIs and the set of entity KPIs (e.g., as determined both together or both separately), may be indicative of meeting a condition associated with the set of value criteria for the communication network functionality. The configuration 536 may be utilized by the network device for communications with other network devices, as described herein, in accordance with aspects for the KVI and KPI framework.

If the condition/target is not met, at 530, the mitigation strategy may be implemented (e.g., iteratively) to refine the use case, reformulate prioritization, or cancel the framework flow. At 532, the use case (e.g., the use case KVI and enabler KVI targets) may be redefined, and the framework flow may return to 504 and start over. If a redefinition of the use case is not possible or not feasible, the process may be abandoned/canceled.

FIG. 6 is a diagram 600 illustrating an example of a KVI and KPI framework, in various aspects. Diagram 600 may be an aspect of the call flow diagram 400 in FIG. 4. In diagram 600, technology enabler selection and configuration (e.g., for a network device, such as the network device 402 in FIG. 4) may be based on KVI and KPI targets defined in the use case definition herein. Diagram 600 illustrates a KVI assessment and optimization loop 680 and a KPI assessment and optimization loop 682 (e.g., for configurable N₁ and N₂ numbers of iterations, respectively), for improving the achievable KVI and KPI, that is performed separately, but for both of KVIs and KPIs.

As noted above, the example framework in diagram 600 may start with a value as the goal (at 602). As one example, the goal may be one of the U.N.SDGs, such as but not limited to, climate action, digital inclusion, reduced inequalities, personal health and protection from harm, access to quality education, privacy and confidentiality, biodiversity, etc. For instance, the goal (at 602) may be to enable learning and improve comprehension (e.g., via digital inclusion, access to quality education, etc.).

Regarding goals, use case/implementation definitions may take into account the technical goals, business goals, human and planetary goals, etc., such as to enable learning and improve comprehension, as noted for an example above. At 604, a use case may be defined, such as within a scenario/context to define specific outcomes with narrower focus on location, population, or activity, and including technology deployment and user action details. In aspects, this may include developing a vision of improvement from a current state of matters. Continuing the example, this may include enabling learning and improving comprehension using Mixed Reality (MR) collaboration and/or immersive platforms and services.

At 606, a relevant value as a goal for the given use case may be selected (which may include a relevant key values being derived), and at 608, a relevant key value as outcome may be derived and/or a use case scope may be identified (e.g., identify the scope for a given use case). Continuing with the example above, for sensations, students may benefit from being able to touch, see, manipulate models. In aspects, relevant key values (e.g., values as outcomes) may be determined at 606, and for each relevant goal, the positive and negative impact(s) of the use case and technology/enabler on the high-level human and planetary goals may be formulated (e.g., these may be key values (or value as outcomes)). A positive impact of a use case and a technology use may be maximized, while negative impacts may be minimized. In aspects, key values may be identified in the three sustainability pillars, e.g., in association with use case (e.g., economic sustainability (benefit: increased level of education/training for the population, impact: cost of extended reality (XR) platforms for the enterprises/universities); social sustainability (benefit: enhanced inclusion due to enhanced ability to interact with local and remote students/teachers, impact: digital divide), and environmental sustainability (benefit: reduced travel as a result of remote work/study, impact: carbon dioxide footprint associated with the running of services and devices)).

The technical scope/parameters (e.g., KPIs) may be defined and analyzed. Functional service parameters for given use case may be identified (e.g., for key performances) at 610 (e.g., select relevant key performances for the given use case). For example, in an immersive learning use case, a virtual classroom may be identified for creating an engaging and immersive virtual learning environment. KPIs and their targets for the given UC may be identified and selected at 612, such as for network throughputs, E2E latency, network coverage, etc. (e.g., identify KPIs and their target).

At 614, use case KVI and target value may be determined. Use case/implementation KVIs may be linked to positive and negative impact(s) of the use case (e.g., the positive and negative impact of the technology use may be part of the enabler KVIs). For each of the key values (from 606), measurable (e.g., qualitatively or quantitatively) indicators may be found as the KVIs. For each of the KVIs, a target may be set as an absolute target value or a relative target value (e.g., a change) with respect to a baseline. The baselines for relative targets (e.g. a current matter status or a status quo) may be determined. Continuing with the example above, such change may be associated with improved engagement measured as, for example, a. number of attendees, hours of attendance/participations of audience based on questions asked, interactions with three-dimensional models, etc., an average retention time, online engagement, improved test scores, improved comprehension, and/or the like. From the use case KVIs and target/base line, technical characteristics for enablers may be determined (at 616).

At 618, aspects provide for a determination of the technology enablers, enabler/entity KVIs, targets KPIs, and performance targets, e.g., as technical realization. The technology components/enablers that impact key values and the overall use case feasibility may be determined. As one case, for each technology enabler, associated indicators (e.g., the enabler KVIs) with respect to the three sustainability pillars may be determined. In continuation of the example from above, XR may be determined over 6G, by way of example, for determining the technology enablers. In such a context, for XR over 6G, in the example there may be economic sustainability (benefit: enabling the immersion and helping with skill building, impact: cost of additional hardware for XR and high spectrum usage); social sustainability (benefit: improving accessibility to content, impact: greater dependence on technology), and environmental sustainability (benefit: lowering the carbon dioxide footprint because of reduced travel, impact: marginal for transportation-carbon dioxide footprint associated with the running of services and devices).

At 625, associated ones of enabler KVIs 690 may be determined, e.g., the KVIs may be assessed for the selected technology enabler (e.g., at 618). At 624, a condition may be determined, e.g., “are the KVIs fulfilling or meeting the target?” If the enabler KVIs 690 are above or meeting the target, the framework may then proceed to 627; otherwise, to 626. At 626, a mitigation strategy for each enabler KVIs 690 may be implemented, and the gap between the achieved KVI and the desired KVI targets may be calculated. The enabler parameters may be modified or adjusted such that the KVIs are in range. This KVI assessment and optimization loop 680 may continue for a number N₁ number of iterations, and the number of iterations may be configured/programmed. During a first performance of the KVI assessment and optimization loop 680, and/or during subsequent iterations thereof for adjustments, such assessment and/or optimization for adjustments may also be based on an AI/ML model 699. In aspects, the A I/ML model 699 may be associated with (e.g., trained on) KVI and KPI training sets that include one or more of current or prior KVIs and/or KPIs for the selected technology enabler, and/or may include one or more of current or prior KVIs and/or KPIs for a different technology enabler(s).

At 619, associated ones of the enabler KPIs 692 may be determined, e.g., the KPIs may be assessed for the selected technology enabler (e.g., at 618). At 622, a condition may be determined, e.g., “are the KPIs fulfilling or meeting the target?” If the enabler KPIs 692 are above or meeting the target, the framework may then proceed to 627; otherwise, to 620. At 620, the gap between the achieved KPI and the desired KPI targets may be calculated. The enabler parameters may be modified or adjusted such that the KPI targets are respected. This KPI assessment and optimization loop 682 may continue for a number N₂ number of iterations, and the number of iterations may be configured/programmed. During a first performance of the KPI assessment and optimization loop 682, and/or during subsequent iterations thereof for adjustments, such assessment and/or optimization for adjustments may also be based on an AI/ML model 699. In aspects, the AI/ML model 699 may be associated with (e.g., trained on) KVI and KPI training sets that include one or more of current or prior KVIs and/or KPIs for the selected technology enabler, and/or may include one or more of current or prior KVIs and/or KPIs for a different technology enabler(s).

If the enabler KVIs 690/the enabler KPIs 692 are both above or meeting the target (e.g., at 622, at 624), the framework may then proceed to 628. A mitigation strategy for each enabler KVI is also provided, in aspects, and may utilize the enabler KVIs 690 and the enabler KPIs 692, described above, for use case KVI assessment at 628. The use case KVIs identified at 614 may also be utilized at 628 for the assessment. In aspects, all KVIs and KPIs may be jointly assessed, together, at this stage. At 630, a condition may be determined as to whether the use case KVI and the enabler KVI are sufficient/acceptable. If the use case KVI and the enabler KVI meet/are above the target, then a configuration 636 for a network device may be generated at 634. Accordingly, the configuration 636 may be for at least one functional parameter and may be based on (i) a set of KVIs, for a set of key values that correspond to a set of value criteria associated with communication network functionality, and (ii) at least one target value for a set of KPIs associated with the communication network functionality. In aspects, the configuration 636 may be indicative of (i) a set of entity KVIs (e.g., enabler KVIs 690), for the network device, associated with the set of KVIs and (ii) a set of entity KPIs (e.g., enabler KPIs 692), for the network device, associated with the set of KPIs at 612. Characteristics of the network device, jointly for the set of entity KVIs and the set of entity KPIs (e.g., as determined both together or both separately), may be indicative of meeting a condition associated with the set of value criteria for the communication network functionality. The configuration 636 may be utilized by the network device for communications with other network devices, as described herein, in accordance with aspects for the KVI and KPI framework.

If the condition/target is not met, at 630, the mitigation strategy may be implemented (e.g., iteratively) to refine the use case, reformulate prioritization, or cancel the framework flow. At 632, the use case (e.g., the use case KVI and enabler KVI targets) may be redefined, and the framework flow may return to 604 and start over. If a redefinition of the use case is not possible or not feasible, the process may be abandoned/canceled.

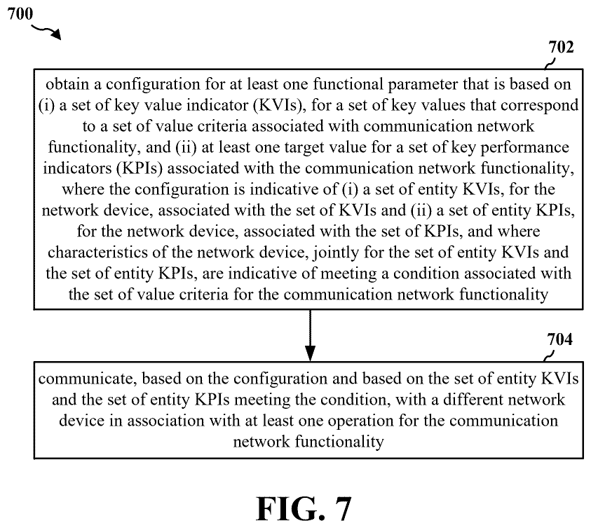

FIG. 7 is a flowchart 700 of a method of wireless communication. The method may be performed by a UE (e.g., the UE 104; the apparatus 1004), by a base station/gNB, a network entity/function, and/or the like (e.g., the base station 102; the network entity 1002, 1102, 1260). In some aspects, the method may include aspects described in connection with the communication flow in FIG. 4 and/or aspects described in FIGS. 5, 6. The method may be for KVI and KPI frameworks. The method may enable continued satisfaction for respective targets on KVIs and KPIs in use cases to promote, improve, and maintain sustainability, e.g., in the contexts of environmental, social, and economic sustainability, and performance together by providing KVI and KPI frameworks for analyzing given use cases with respect to their KVs, KVIs, and KPIs, and may also enable continued tracking and improvements for sustainability considerations, e.g., in the contexts of environmental, social, and economic sustainability, by providing collected data and/or feedback information associated with KVIs/KPIs associated with a network device.

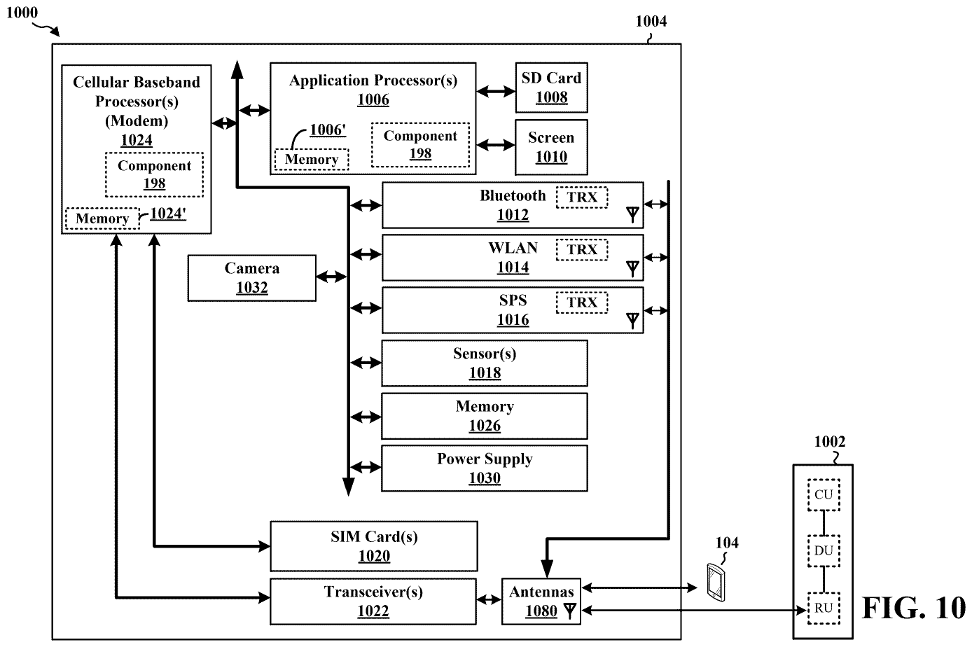

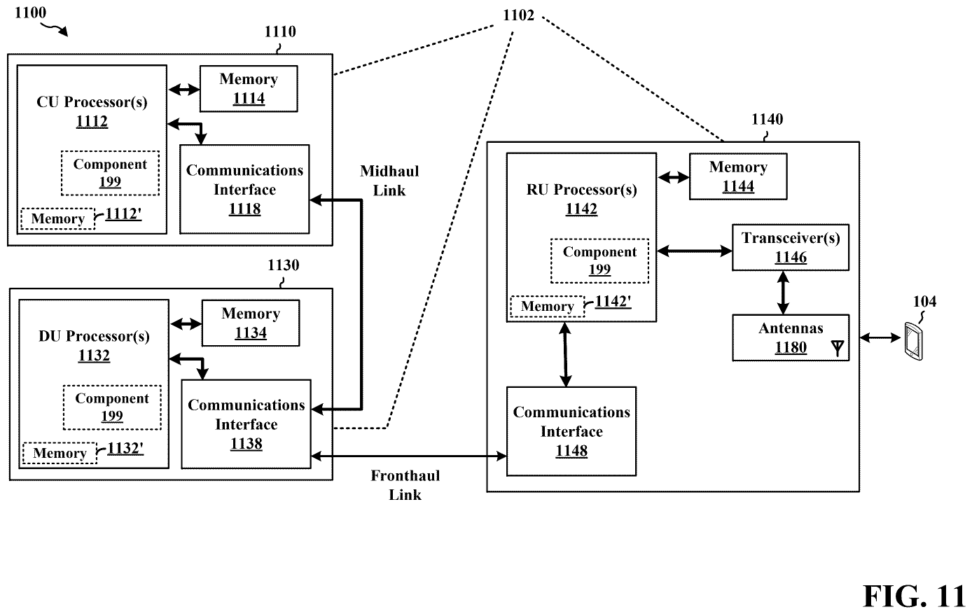

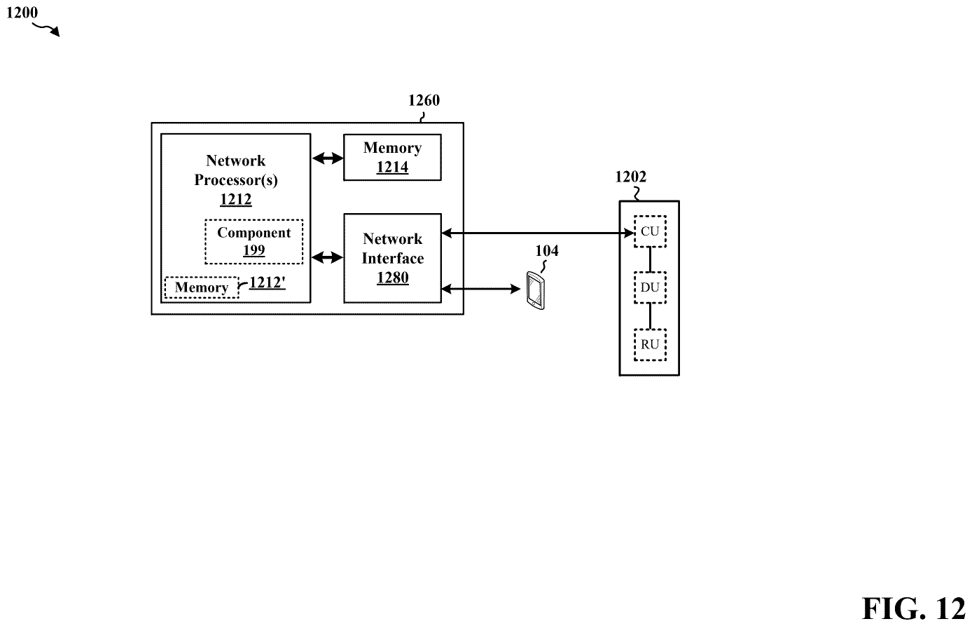

At 702, the network device obtains a configuration for at least one functional parameter that is based on (i) a set of key value indicator (KVIs), for a set of key values that correspond to a set of value criteria associated with communication network functionality, and (ii) at least one target value for a set of key performance indicators (KPIs) associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. As an example, the obtainment may be performed by one or more of the component 199, the transceiver(s) 1022 and/or the antenna 1080 in FIG. 10, the transceiver(s) 1146 and/or the antenna 1180 in FIG. 11, the network interface 1280 in FIG. 12, etc. FIG. 4 illustrates, in the context of FIGS. 5, 6, an example of the network device 402 obtaining such a configuration.

The network device 402 may be configured to obtain (at 406) (e.g., at 534 in FIG. 5; at 634 in FIG. 6) a configuration 407 (e.g., 536 in FIG. 5; at 636 in FIG. 6) for at least one functional parameter (e.g., of 504 and 518 in FIG. 5; of 604 and 618 in FIG. 6) that is based on (i) a set of KVIs (e.g., 590 in FIG. 5; 690 in FIG. 6), for a set of key values (e.g., at 506 in FIG. 5; at 606 in FIG. 6) that correspond to a set of value criteria associated with communication network functionality, and (ii) at least one target value (e.g., at 512 in FIG. 5; at 612 in FIG. 6) for a set of KPIs (e.g., 592 in FIG. 5; 692 in FIG. 6) associated with the communication network functionality. In aspects, the configuration 407 (e.g., 536 in FIG. 5; at 636 in FIG. 6) may be indicative of (i) a set of entity KVIs (e.g., enabler KVIs) (e.g., 590 in FIG. 5; 690 in FIG. 6), for the network device 402, associated with the set of KVIs (e.g., 590 in FIG. 5; 690 in FIG. 6) and (ii) a set of entity KPIs (e.g., enabler KPIs) (e.g., 592 in FIG. 5; 692 in FIG. 6), for the network device 402, associated with the set of KPIs (e.g., 592 in FIG. 5; 692 in FIG. 6). Characteristics of the network device 402, jointly for the set of entity KVIs (e.g., 590 in FIG. 5; 690 in FIG. 6) and the set of entity KPIs (e.g., 592 in FIG. 5; 692 in FIG. 6) (e.g., as determined both together or both separately), may be indicative of meeting a condition (e.g., at 522 in FIG. 5; at 622, at 624 in FIG. 6) associated with the set of value criteria for the communication network functionality. In some aspects, the communication network functionality may include non-communicative operations at the network device 402. Non communicative operations may include, without limitation, use case level statistics associated with a specific use case (e.g., engagement, effectiveness, attention to content, etc.), and/or the like, when such information is available to the network device 402. In aspects, the set of key values (e.g., at 506 in FIG. 5; at 606 in FIG. 6) may include at least one of a set of economic criteria, a set of social criteria, a set of environmental criteria, and/or the like, and the set of KVIs (e.g., 590 in FIG. 5; 690 in FIG. 6) may be indicative of quantified or qualified effects that correspond to the set of key values (e.g., at 506 in FIG. 5; at 606 in FIG. 6). In such aspects, the set of KVIs (e.g., 590 in FIG. 5; 690 in FIG. 6) may include at least one implementation KVI associated with an improvement effect (e.g., at 526 in FIG. 5; at 626 in FIG. 6) for the set of key values (e.g., at 506 in FIG. 5; at 606 in FIG. 6). In aspects, the set of KPIs (e.g., 592 in FIG. 5; 692 in FIG. 6) may include at least one measurement of performance for a communication network. In such aspects, the at least one measurement may be associated with one or more of a network coverage, a signal-to-noise ratio (SNR), a signal to interference and noise ratio (SINR), a mobility metric, a power consumption, a network throughput, a network latency, and/or the like.

The network device 402, to obtain (e.g., at 534 in FIG. 5; at 634 in FIG. 6) the configuration 407 (e.g., 536 in FIG. 5; at 636 in FIG. 6), may be configured to receive the configuration 407 (e.g., 536 in FIG. 5; at 636 in FIG. 6) in accordance with a selection (e.g., at 518 in FIG. 5; at 618 in FIG. 6) of the network device 402, from a set of network devices, that is based on the network device 402 meeting the condition (e.g., at 522 in FIG. 5; at 622, at 624 in FIG. 6).

At 704, the network device communicates, based on the configuration and based on the set of entity KVIs and the set of entity KPIs meeting the condition, with a different network device in association with at least one operation for the communication network functionality. As an example, the communication may be performed by one or more of the component 199, the transceiver(s) 1022 and/or the antenna 1080 in FIG. 10, the transceiver(s) 1146 and/or the antenna 1180 in FIG. 11, the network interface 1280 in FIG. 12, etc. FIG. 4 illustrates, in the context of FIGS. 5, 6, an example of the network device 402 communicating with such a network device (e.g., the UE 403, the base station 404, the entity/function of the core network 405).

The network device 402 may be configured to communicate (at 408), based on the configuration 407 (e.g., 536 in FIG. 5; at 636 in FIG. 6) and based on the set of entity KVIs (e.g., 590 in FIG. 5; 690 in FIG. 6) and the set of entity KPIs (e.g., 592 in FIG. 5; 692 in FIG. 6) meeting the condition (e.g., at 522 in FIG. 5; at 622, at 624 in FIG. 6), with a different network device (e.g., the UE 403, the base station 404, the entity/function of the core network 405, and/or the like) in association with at least one operation for the communication network functionality. The network device 402, to communicate (at 408) with the different network device in association with the communication network functionality, may be configured to communicate over at least one of a core network, a RAN, a LAN, or a point-to-point wireless connection. To communicate (at 408) with the different network device in association with the communication network functionality, the network device may be configured to communicate (at 408) based on a software application executed at a UE (e.g., the UE 403). The software application may be associated with the set of key values (e.g., at 506 in FIG. 5; at 606 in FIG. 6), in aspects, and to communicate with the different network device in association with the communication network functionality, the network device 402 may be configured to receive, from the UE 403, one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6).

The UE 403 may be configured to receive, from the network device 402 and in accordance with a configuration 407 (e.g., 536 in FIG. 5; at 636 in FIG. 6) for at least one functional parameter (e.g., of 504 and 518 in FIG. 5; of 604 and 618 in FIG. 6) of the network device 402, at least one communication 410 associated with an operation for communication network functionality, where the configuration 407 (e.g., 536 in FIG. 5; at 636 in FIG. 6) is based on (i) a set of key value indicator (KVIs) (e.g., 590 in FIG. 5; 690 in FIG. 6), for a set of key values (e.g., at 506 in FIG. 5; at 606 in FIG. 6) that correspond to a set of value criteria associated with the communication network functionality, and (ii) at least one target value (e.g., at 512 in FIG. 5; at 612 in FIG. 6) for a set of key performance indicators (KPIs) (e.g., 592 in FIG. 5; 692 in FIG. 6) associated with the communication network functionality.

The UE 403 may be configured to provide (at 412), and the network device 402 may be configured to receive, based on the at least one communication 410, one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6). In aspects, to receive one or more of the collected data or feedback information 414, the network device 402 may be configured to receive one or more of the collected data or feedback information 414 based on at least one of a reporting periodicity or a reporting content configuration. The UE 403, to receive the at least one communication 410 and/or to provide one or more of the collected data or feedback information 414, may be configured to communicate over at least one of a core network, a RAN, a LAN, or a point-to-point wireless connection. The at least one communication 410 may be indicative of at least one of a reporting periodicity or a reporting content configuration associated with one or more of the collected data or feedback information 414. In aspects, one or more of the collected data or feedback information 414 may correspond to a software application, executed at the UE 403, that is associated with the set of key values (e.g., at 506 in FIG. 5; at 606 in FIG. 6). In aspects, one or more of the collected data or feedback information 414 may be associated with a set of values for at least one of the set of KPIs (e.g., 592 in FIG. 5; 692 in FIG. 6) or the set of KVIs (e.g., 590 in FIG. 5; 690 in FIG. 6).

The UE 403, to provide (at 412) for the network device 402 and based on the at least one communication 410, one or more of the collected data or feedback information 414, may be configured to provide (at 412) one or more of the collected data or feedback information 414 based on at least one of the reporting periodicity or the reporting content configuration.

The network device 402 may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6) of the network device 402 based on at least one of the set of KVIs (e.g., 590 in FIG. 5; 690 in FIG. 6) or the set of KPIs (e.g., 592 in FIG. 5; 692 in FIG. 6) failing to meet the condition (e.g., at 522 in FIG. 5; at 622, at 624 in FIG. 6). In aspects, to adjust (e.g., at 526 in FIG. 5; at 626, at 620 in FIG. 6) the at least one functional parameter (e.g., of 504 and 518 in FIG. 5; of 604 and 618 in FIG. 6), the network device 402 may be configured to adjust (e.g., at 526 in FIG. 5; at 626, at 620 in FIG. 6) the at least one functional parameter (e.g., of 504 and 518 in FIG. 5; of 604 and 618 in FIG. 6) prior to the at least one operation and/or may be configured to communicate (e.g., at 408) as a portion of the at least one operation, with at least one of a UE (e.g., the UE 403) or a base station (e.g., the base station 404), and to receive, from at least one of the UE (e.g., the UE 403) or the base station (e.g., the base station 404), one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6) after the prior adjustment (e.g., at 526 in FIG. 5; at 626, at 620 in FIG. 6). In aspects, the one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6) may be indicative of the network device 402 meeting, or failing to meet, the condition (e.g., at 522 in FIG. 5; at 622, at 624 in FIG. 6). In aspects, the condition (e.g., at 522 in FIG. 5; at 622, at 624 in FIG. 6) may comprise a KPI condition (e.g., at 522 in FIG. 5; at 624 in FIG. 6) and a KVI condition (e.g., at 522 in FIG. 5; at 624 in FIG. 6), and the network device 402, to adjust (at 416) (e.g., at 526 in FIG. 5; at 626, at 620 in FIG. 6) the at least one functional parameter (e.g., of 504 and 518 in FIG. 5; of 604 and 618 in FIG. 6), may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6), based on at least one of (i) a set of iterations (e.g., 580 in FIG. 5; 680, 682 in FIG. 6) or (ii) a machine learning (AI)/artificial intelligence (ML) (AI/ML) model (e.g., 599 in FIG. 5; 699 in FIG. 6) associated with KVI and KPI training sets, for changes to one or more of the set of KVIs (e.g., 590 in FIG. 5; 690 in FIG. 6) or the set of KPIs (e.g., 592 in FIG. 5; 692 in FIG. 6) until separately the set of KVIs (e.g., 590 in FIG. 5; 690 in FIG. 6) meets the KVI condition (e.g., at 522 in FIG. 5; at 624 in FIG. 6) and the set of KPIs (e.g., 592 in FIG. 5; 692 in FIG. 6) meet the KPI condition (e.g., at 522 in FIG. 5; at 622 in FIG. 6).

In aspects, to adjust (at 416) (e.g., at 526 in FIG. 5; at 626, at 620 in FIG. 6) the at least one functional parameter (e.g., of 504 and 518 in FIG. 5; of 604 and 618 in FIG. 6), the network device 402 may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6), based on at least one of (i) a set of iterations (e.g., 580 in FIG. 5; 680, 682 in FIG. 6) or (ii) a machine learning (AI)/artificial intelligence (M L) (AI/ML) model (e.g., 599 in FIG. 5; 699 in FIG. 6) associated with KVI and KPI training sets, for changes to one or more of the set of KVIs (e.g., 590 in FIG. 5; 690 in FIG. 6) or the set of KPIs (e.g., 592 in FIG. 5; 692 in FIG. 6) until the set of KVIs (e.g., 590 in FIG. 5; 690 in FIG. 6) and the set of KPIs (e.g., 592 in FIG. 5; 692 in FIG. 6) jointly meet the condition (e.g., at 522 in FIG. 5; at 622, at 624 in FIG. 6) together. The network device 402, jointly for the set of entity KVIs (e.g., 590 in FIG. 5; 690 in FIG. 6) and the set of entity KPIs (e.g., 592 in FIG. 5; 692 in FIG. 6), may meet the condition (e.g., at 522 in FIG. 5; at 622, at 624 in FIG. 6) associated with the set of value criteria for the communication network functionality based on a condition determination ((e.g., at 530 in FIG. 5; at 630 in FIG. 6)) of both of the set of entity KVIs (e.g., 590 in FIG. 5; 690 in FIG. 6) and the set of entity KPIs together. In aspects, the condition may comprise a KPI condition (e.g., at 622 in FIG. 6) and a KVI condition (e.g., at 624 in FIG. 6), and the network device 402 may meet the KVI condition (e.g., at 624 in FIG. 6) for the set of entity KVIs (e.g., 590 in FIG. 5; 690 in FIG. 6) and separately may meet the KPI condition (e.g., at 622 in FIG. 6) for the set of entity KPIs (e.g., 592 in FIG. 5; 692 in FIG. 6), in association with the set of value criteria for the communication network functionality based on a condition determination (e.g., at 530 in FIG. 5; at 630 in FIG. 6) of both of the set of entity KVIs (e.g., 590 in FIG. 5; 690 in FIG. 6) and the set of entity KPIs (e.g., 592 in FIG. 5; 692 in FIG. 6) separately.

In aspects, the network device 402 may be configured communicate, subsequent to the adjustment (at 416) (e.g., at 526 in FIG. 5; at 626, at 620 in FIG. 6) an additional communication(s) 418. The additional communication(s) 418 may thus be based on the adjustment (at 416) (e.g., at 526 in FIG. 5; at 626, at 620 in FIG. 6) for a functional parameter(s) (e.g., of 504 and 518 in FIG. 5; of 604 and 618 in FIG. 6) (e.g., an adjusted functional parameter(s)) of the network device 402 based on at least one of the set of KVIs (e.g., 590 in FIG. 5; 690 in FIG. 6)/the set of KPIs (e.g., 592 in FIG. 5; 692 in FIG. 6) failing to meet the condition (e.g., at 522 in FIG. 5; at 622, at 624 in FIG. 6) and a subsequent adjustment (at 416) (e.g., at 526 in FIG. 5; at 626, at 620 in FIG. 6) therefor to maintain KVIs/KPIs and/or sustainability, e.g., in the contexts of environmental, social, and economic sustainability.

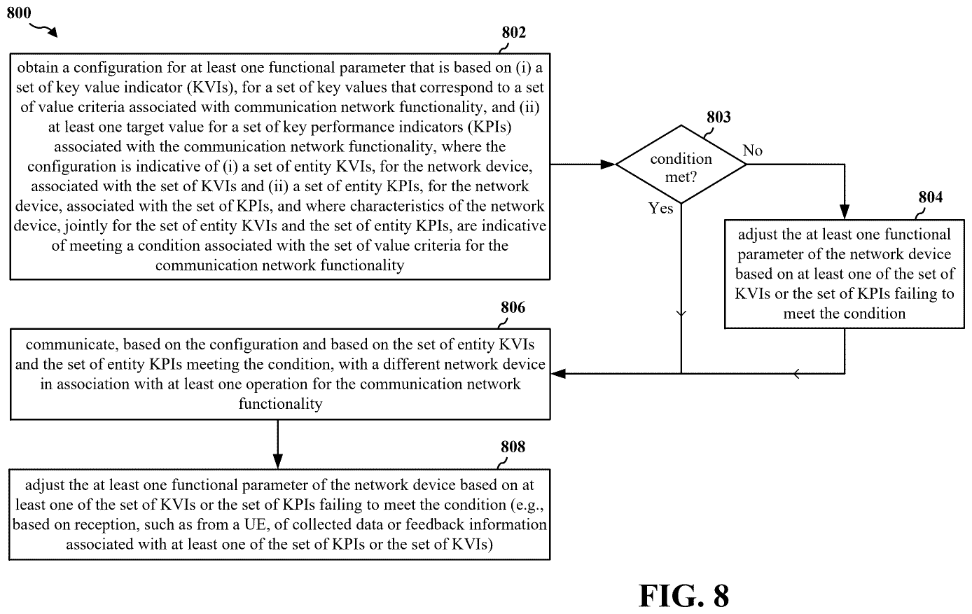

FIG. 8 is a flowchart 800 of a method of wireless communication. The method may be performed by a UE (e.g., the UE 104; the apparatus 1004), by a base station/gNB, a network entity/function, and/or the like (e.g., the base station 102; the network entity 1002, 1102, 1260). In some aspects, the method may include aspects described in connection with the communication flow in FIG. 4 and/or aspects described in FIGS. 5, 6. The method may be for KVI and KPI frameworks. The method may enable continued satisfaction for respective targets on KVIs and KPIs in use cases to promote, improve, and maintain sustainability, e.g., in the contexts of environmental, social, and economic sustainability, and performance together by providing KVI and KPI frameworks for analyzing given use cases with respect to their KVs, KVIs, and KPIs, and may also enable continued tracking and improvements for sustainability considerations, e.g., in the contexts of environmental, social, and economic sustainability, by providing collected data and/or feedback information associated with KVIs/KPIs associated with a network device.

At 802, the network device obtains a configuration for at least one functional parameter that is based on (i) a set of key value indicator (KVIs), for a set of key values that correspond to a set of value criteria associated with communication network functionality, and (ii) at least one target value for a set of key performance indicators (KPIs) associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. As an example, the obtainment may be performed by one or more of the component 199, the transceiver(s) 1022 and/or the antenna 1080 in FIG. 10, the transceiver(s) 1146 and/or the antenna 1180 in FIG. 11, the network interface 1280 in FIG. 12, etc. FIG. 4 illustrates, in the context of FIGS. 5, 6, an example of the network device 402 obtaining such a configuration.

The network device 402 may be configured to obtain (at 406) (e.g., at 534 in FIG. 5; at 634 in FIG. 6) a configuration 407 (e.g., 536 in FIG. 5; at 636 in FIG. 6) for at least one functional parameter (e.g., of 504 and 518 in FIG. 5; of 604 and 618 in FIG. 6) that is based on (i) a set of KVIs (e.g., 590 in FIG. 5; 690 in FIG. 6), for a set of key values (e.g., at 506 in FIG. 5; at 606 in FIG. 6) that correspond to a set of value criteria associated with communication network functionality, and (ii) at least one target value (e.g., at 512 in FIG. 5; at 612 in FIG. 6) for a set of KPIs (e.g., 592 in FIG. 5; 692 in FIG. 6) associated with the communication network functionality. In aspects, the configuration 407 (e.g., 536 in FIG. 5; at 636 in FIG. 6) may be indicative of (i) a set of entity KVIs (e.g., enabler KVIs) (e.g., 590 in FIG. 5; 690 in FIG. 6), for the network device 402, associated with the set of KVIs (e.g., 590 in FIG. 5; 690 in FIG. 6) and (ii) a set of entity KPIs (e.g., enabler KPIs) (e.g., 592 in FIG. 5; 692 in FIG. 6), for the network device 402, associated with the set of KPIs (e.g., 592 in FIG. 5; 692 in FIG. 6). Characteristics of the network device 402, jointly for the set of entity KVIs (e.g., 590 in FIG. 5; 690 in FIG. 6) and the set of entity KPIs (e.g., 592 in FIG. 5; 692 in FIG. 6) (e.g., as determined both together or both separately), may be indicative of meeting a condition (e.g., at 522 in FIG. 5; at 622, at 624 in FIG. 6) associated with the set of value criteria for the communication network functionality. In some aspects, the communication network functionality may include non-communicative operations at the network device 402. Non communicative operations may include, without limitation, use case level statistics associated with a specific use case (e.g., engagement, effectiveness, attention to content, etc.), and/or the like, when such information is available to the network device 402. In aspects, the set of key values (e.g., at 506 in FIG. 5; at 606 in FIG. 6) may include at least one of a set of economic criteria, a set of social criteria, a set of environmental criteria, and/or the like, and the set of KVIs (e.g., 590 in FIG. 5; 690 in FIG. 6) may be indicative of quantified or qualified effects that correspond to the set of key values (e.g., at 506 in FIG. 5; at 606 in FIG. 6). In such aspects, the set of KVIs (e.g., 590 in FIG. 5; 690 in FIG. 6) may include at least one implementation KVI associated with an improvement effect (e.g., at 526 in FIG. 5; at 626 in FIG. 6) for the set of key values (e.g., at 506 in FIG. 5; at 606 in FIG. 6). In aspects, the set of KPIs (e.g., 592 in FIG. 5; 692 in FIG. 6) may include at least one measurement of performance for a communication network. In such aspects, the at least one measurement may be associated with one or more of a network coverage, a signal-to-noise ratio (SNR), a signal to interference and noise ratio (SINR), a mobility metric, a power consumption, a network throughput, a network latency, and/or the like.

The network device 402, to obtain (e.g., at 534 in FIG. 5; at 634 in FIG. 6) the configuration 407 (e.g., 536 in FIG. 5; at 636 in FIG. 6), may be configured to receive the configuration 407 (e.g., 536 in FIG. 5; at 636 in FIG. 6) in accordance with a selection (e.g., at 518 in FIG. 5; at 618 in FIG. 6) of the network device 402, from a set of network devices, that is based on the network device 402 meeting the condition (e.g., at 522 in FIG. 5; at 622, at 624 in FIG. 6).

At 803, it is determined whether the condition associated with the set of value criteria for the communication network functionality is met. The determination may be performed by one or more of the component 199, the transceiver(s) 1022 and/or the antenna 1080 in FIG. 10, the transceiver(s) 1146 and/or the antenna 1180 in FIG. 11, the network interface 1280 in FIG. 12, etc. If the condition is met, flowchart 800 may continue to 806; if not, flowchart 800 may continue to 804.

At 804, the network device adjusts the at least one functional parameter of the network device based on at least one of the set of KVIs or the set of KPIs failing to meet the condition. As an example, the adjustment may be performed by one or more of the component 199, the transceiver(s) 1022 and/or the antenna 1080 in FIG. 10, the transceiver(s) 1146 and/or the antenna 1180 in FIG. 11, the network interface 1280 in FIG. 12, etc. FIG. 4 illustrates, in the context of FIGS. 5, 6, an example of the network device 402 adjusting such a functional parameter(s).

The network device 402 may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6) of the network device 402 based on at least one of the set of KVIs (e.g., 590 in FIG. 5; 690 in FIG. 6) or the set of KPIs (e.g., 592 in FIG. 5; 692 in FIG. 6) failing to meet the condition (e.g., at 522 in FIG. 5; at 622, at 624 in FIG. 6). In aspects, to adjust (e.g., at 526 in FIG. 5; at 626, at 620 in FIG. 6) the at least one functional parameter (e.g., of 504 and 518 in FIG. 5; of 604 and 618 in FIG. 6), the network device 402 may be configured to adjust (e.g., at 526 in FIG. 5; at 626, at 620 in FIG. 6) the at least one functional parameter (e.g., of 504 and 518 in FIG. 5; of 604 and 618 in FIG. 6) prior to the at least one operation and/or may be configured to communicate (e.g., at 408) as a portion of the at least one operation, with at least one of a UE (e.g., the UE 403) or a base station (e.g., the base station 404), and to receive, from at least one of the UE (e.g., the UE 403) or the base station (e.g., the base station 404), one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6) after the prior adjustment (e.g., at 526 in FIG. 5; at 626, at 620 in FIG. 6). In aspects, to adjust (at 416) (e.g., at 526 in FIG. 5; at 626, at 620 in FIG. 6) the at least one functional parameter (e.g., of 504 and 518 in FIG. 5; of 604 and 618 in FIG. 6), the network device 402 may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6), based on at least one of (i) a set of iterations (e.g., 580 in FIG. 5; 680, 682 in FIG. 6) or (ii) a machine learning (AI)/artificial intelligence (ML) (AI/ML) model (e.g., 599 in FIG. 5; 699 in FIG. 6) associated with KVI and KPI training sets, for changes to one or more of the set of KVIs (e.g., 590 in FIG. 5; 690 in FIG. 6) or the set of KPIs (e.g., 592 in FIG. 5; 692 in FIG. 6) until the set of KVIs (e.g., 590 in FIG. 5; 690 in FIG. 6) and the set of KPIs (e.g., 592 in FIG. 5; 692 in FIG. 6) jointly meet the condition (e.g., at 522 in FIG. 5; at 622, at 624 in FIG. 6) together. The network device 402, jointly for the set of entity KVIs (e.g., 590 in FIG. 5; 690 in FIG. 6) and the set of entity KPIs (e.g., 592 in FIG. 5; 692 in FIG. 6), may meet the condition (e.g., at 522 in FIG. 5; at 622, at 624 in FIG. 6) associated with the set of value criteria for the communication network functionality based on a condition determination ((e.g., at 530 in FIG. 5; at 630 in FIG. 6)) of both of the set of entity KVIs (e.g., 590 in FIG. 5; 690 in FIG. 6) and the set of entity KPIs together. In aspects, the condition may comprise a KPI condition (e.g., at 622 in FIG. 6) and a KVI condition (e.g., at 624 in FIG. 6), and the network device 402 may meet the KVI condition (e.g., at 624 in FIG. 6) for the set of entity KVIs (e.g., 590 in FIG. 5; 690 in FIG. 6) and separately may meet the KPI condition (e.g., at 622 in FIG. 6) for the set of entity KPIs (e.g., 592 in FIG. 5; 692 in FIG. 6), in association with the set of value criteria for the communication network functionality based on a condition determination (e.g., at 530 in FIG. 5; at 630 in FIG. 6) of both of the set of entity KVIs (e.g., 590 in FIG. 5; 690 in FIG. 6) and the set of entity KPIs (e.g., 592 in FIG. 5; 692 in FIG. 6) separately.

At 806, the network device communicates, based on the configuration and based on the set of entity KVIs and the set of entity KPIs meeting the condition, with a different network device in association with at least one operation for the communication network functionality. As an example, the communication may be performed by one or more of the component 199, the transceiver(s) 1022 and/or the antenna 1080 in FIG. 10, the transceiver(s) 1146 and/or the antenna 1180 in FIG. 11, the network interface 1280 in FIG. 12, etc. FIG. 4 illustrates, in the context of FIGS. 5, 6, an example of the network device 402 communicating with such a network device (e.g., the UE 403, the base station 404, the entity/function of the core network 405).

The network device 402 may be configured to communicate (at 408), based on the configuration 407 (e.g., 536 in FIG. 5; at 636 in FIG. 6) and based on the set of entity KVIs (e.g., 590 in FIG. 5; 690 in FIG. 6) and the set of entity KPIs (e.g., 592 in FIG. 5; 692 in FIG. 6) meeting the condition (e.g., at 522 in FIG. 5; at 622, at 624 in FIG. 6), with a different network device (e.g., the UE 403, the base station 404, the entity/function of the core network 405, and/or the like) in association with at least one operation for the communication network functionality. The network device 402, to communicate (at 408) with the different network device in association with the communication network functionality, may be configured to communicate over at least one of a core network, a RAN, a LAN, or a point-to-point wireless connection. To communicate (at 408) with the different network device in association with the communication network functionality, the network device may be configured to communicate (at 408) based on a software application executed at a UE (e.g., the UE 403). The software application may be associated with the set of key values (e.g., at 506 in FIG. 5; at 606 in FIG. 6), in aspects, and to communicate with the different network device in association with the communication network functionality, the network device 402 may be configured to receive, from the UE 403, one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6).

The UE 403 may be configured to receive, from the network device 402 and in accordance with a configuration 407 (e.g., 536 in FIG. 5; at 636 in FIG. 6) for at least one functional parameter (e.g., of 504 and 518 in FIG. 5; of 604 and 618 in FIG. 6) of the network device 402, at least one communication 410 associated with an operation for communication network functionality, where the configuration 407 (e.g., 536 in FIG. 5; at 636 in FIG. 6) is based on (i) a set of key value indicator (KVIs) (e.g., 590 in FIG. 5; 690 in FIG. 6), for a set of key values (e.g., at 506 in FIG. 5; at 606 in FIG. 6) that correspond to a set of value criteria associated with the communication network functionality, and (ii) at least one target value (e.g., at 512 in FIG. 5; at 612 in FIG. 6) for a set of key performance indicators (KPIs) (e.g., 592 in FIG. 5; 692 in FIG. 6) associated with the communication network functionality.

The UE 403 may be configured to provide (at 412), and the network device 402 may be configured to receive, based on the at least one communication 410, one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6). In aspects, to receive one or more of the collected data or feedback information 414, the network device 402 may be configured to receive one or more of the collected data or feedback information 414 based on at least one of a reporting periodicity or a reporting content configuration. The UE 403, to receive the at least one communication 410 and/or to provide one or more of the collected data or feedback information 414, may be configured to communicate over at least one of a core network, a RAN, a LAN, or a point-to-point wireless connection. The at least one communication 410 may be indicative of at least one of a reporting periodicity or a reporting content configuration associated with one or more of the collected data or feedback information 414. In aspects, one or more of the collected data or feedback information 414 may correspond to a software application, executed at the UE 403, that is associated with the set of key values (e.g., at 506 in FIG. 5; at 606 in FIG. 6). In aspects, one or more of the collected data or feedback information 414 may be associated with a set of values for at least one of the set of KPIs (e.g., 592 in FIG. 5; 692 in FIG. 6) or the set of KVIs (e.g., 590 in FIG. 5; 690 in FIG. 6).

The UE 403, to provide (at 412) for the network device 402 and based on the at least one communication 410, one or more of the collected data or feedback information 414, may be configured to provide (at 412) one or more of the collected data or feedback information 414 based on at least one of the reporting periodicity or the reporting content configuration. In aspects, the one or more of collected data or feedback information 414 associated with at least one of the set of KPIs or the set of KVIs may be indicative of the network device 402 meeting, or failing to meet, the condition.

At 808, the network device adjusts the at least one functional parameter of the network device based on at least one of the set of KVIs or the set of KPIs failing to meet the condition. As an example, the adjustment may be performed by one or more of the component 199, the transceiver(s) 1022 and/or the antenna 1080 in FIG. 10, the transceiver(s) 1146 and/or the antenna 1180 in FIG. 11, the network interface 1280 in FIG. 12, etc. FIG. 4 illustrates, in the context of FIGS. 5, 6, an example of the network device 402 adjusting such a functional parameter(s).

The network device 402 may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6) of the network device 402 based on at least one of the set of KVIs (e.g., 590 in FIG. 5; 690 in FIG. 6) or the set of KPIs (e.g., 592 in FIG. 5; 692 in FIG. 6) failing to meet the condition (e.g., at 522 in FIG. 5; at 622, at 624 in FIG. 6). In aspects, to adjust (e.g., at 526 in FIG. 5; at 626, at 620 in FIG. 6) the at least one functional parameter (e.g., of 504 and 518 in FIG. 5; of 604 and 618 in FIG. 6), the network device 402 may be configured to adjust (e.g., at 526 in FIG. 5; at 626, at 620 in FIG. 6) the at least one functional parameter (e.g., of 504 and 518 in FIG. 5; of 604 and 618 in FIG. 6) prior to the at least one operation and/or may be configured to communicate (e.g., at 408) as a portion of the at least one operation, with at least one of a UE (e.g., the UE 403) or a base station (e.g., the base station 404), and to receive, from at least one of the UE (e.g., the UE 403) or the base station (e.g., the base station 404), one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6) after the prior adjustment (e.g., at 526 in FIG. 5; at 626, at 620 in FIG. 6). In aspects, the one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6) may be indicative of the network device 402 meeting, or failing to meet, the condition (e.g., at 522 in FIG. 5; at 622, at 624 in FIG. 6). In aspects, the condition (e.g., at 522 in FIG. 5; at 622, at 624 in FIG. 6) may comprise a KPI condition (e.g., at 522 in FIG. 5; at 624 in FIG. 6) and a KVI condition (e.g., at 522 in FIG. 5; at 624 in FIG. 6), and the network device 402, to adjust (at 416) (e.g., at 526 in FIG. 5; at 626, at 620 in FIG. 6) the at least one functional parameter (e.g., of 504 and 518 in FIG. 5; of 604 and 618 in FIG. 6), may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6), based on at least one of (i) a set of iterations (e.g., 580 in FIG. 5; 680, 682 in FIG. 6) or (ii) a machine learning (AI)/artificial intelligence (ML) (AI/ML) model (e.g., 599 in FIG. 5; 699 in FIG. 6) associated with KVI and KPI training sets, for changes to one or more of the set of KVIs (e.g., 590 in FIG. 5; 690 in FIG. 6) or the set of KPIs (e.g., 592 in FIG. 5; 692 in FIG. 6) until separately the set of KVIs (e.g., 590 in FIG. 5; 690 in FIG. 6) meets the KVI condition (e.g., at 522 in FIG. 5; at 624 in FIG. 6) and the set of KPIs (e.g., 592 in FIG. 5; 692 in FIG. 6) meet the KPI condition (e.g., at 522 in FIG. 5; at 622 in FIG. 6).

In aspects, to adjust (at 416) (e.g., at 526 in FIG. 5; at 626, at 620 in FIG. 6) the at least one functional parameter (e.g., of 504 and 518 in FIG. 5; of 604 and 618 in FIG. 6), the network device 402 may be configured to adjust (at 416) (e.g., at 526 in FIG. 5; at 626, at 620 in FIG. 6) the at least one functional parameter (e.g., of 504 and 518 in FIG. 5; of 604 and 618 in FIG. 6), based on at least one of (i) a set of iterations (e.g., 580 in FIG. 5; 680, 682 in FIG. 6) or (ii) a machine learning (AI)/artificial intelligence (ML) (AI/ML) model (e.g., 599 in FIG. 5; 699 in FIG. 6) associated with KVI and KPI training sets, for changes to one or more of the set of KVIs (e.g., 590 in FIG. 5; 690 in FIG. 6) or the set of KPIs (e.g., 592 in FIG. 5; 692 in FIG. 6) until the set of KVIs (e.g., 590 in FIG. 5; 690 in FIG. 6) and the set of KPIs (e.g., 592 in FIG. 5; 692 in FIG. 6) jointly meet the condition (e.g., at 522 in FIG. 5; at 622, at 624 in FIG. 6) together. The network device 402, jointly for the set of entity KVIs (e.g., 590 in FIG. 5; 690 in FIG. 6) and the set of entity KPIs (e.g., 592 in FIG. 5; 692 in FIG. 6), may meet the condition (e.g., at 522 in FIG. 5; at 622, at 624 in FIG. 6) associated with the set of value criteria for the communication network functionality based on a condition determination ((e.g., at 530 in FIG. 5; at 630 in FIG. 6)) of both of the set of entity KVIs (e.g., 590 in FIG. 5; 690 in FIG. 6) and the set of entity KPIs together. In aspects, the condition may comprise a KPI condition (e.g., at 622 in FIG. 6) and a KVI condition (e.g., at 624 in FIG. 6), and the network device 402 may meet the KVI condition (e.g., at 624 in FIG. 6) for the set of entity KVIs (e.g., 590 in FIG. 5; 690 in FIG. 6) and separately may meet the KPI condition (e.g., at 622 in FIG. 6) for the set of entity KPIs (e.g., 592 in FIG. 5; 692 in FIG. 6), in association with the set of value criteria for the communication network functionality based on a condition determination (e.g., at 530 in FIG. 5; at 630 in FIG. 6) of both of the set of entity KVIs (e.g., 590 in FIG. 5; 690 in FIG. 6) and the set of entity KPIs (e.g., 592 in FIG. 5; 692 in FIG. 6) separately.

In aspects, the network device 402 may be configured communicate, subsequent to the adjustment (at 416) (e.g., at 526 in FIG. 5; at 626, at 620 in FIG. 6) an additional communication(s) 418. The additional communication(s) 418 may thus be based on the adjustment (at 416) (e.g., at 526 in FIG. 5; at 626, at 620 in FIG. 6) for a functional parameter(s) (e.g., of 504 and 518 in FIG. 5; of 604 and 618 in FIG. 6) (e.g., an adjusted functional parameter(s)) of the network device 402 based on at least one of the set of KVIs (e.g., 590 in FIG. 5; 690 in FIG. 6)/the set of KPIs (e.g., 592 in FIG. 5; 692 in FIG. 6) failing to meet the condition (e.g., at 522 in FIG. 5; at 622, at 624 in FIG. 6) and a subsequent adjustment (at 416) (e.g., at 526 in FIG. 5; at 626, at 620 in FIG. 6) therefor to maintain KVIs/KPIs and/or sustainability, e.g., in the contexts of environmental, social, and economic sustainability.

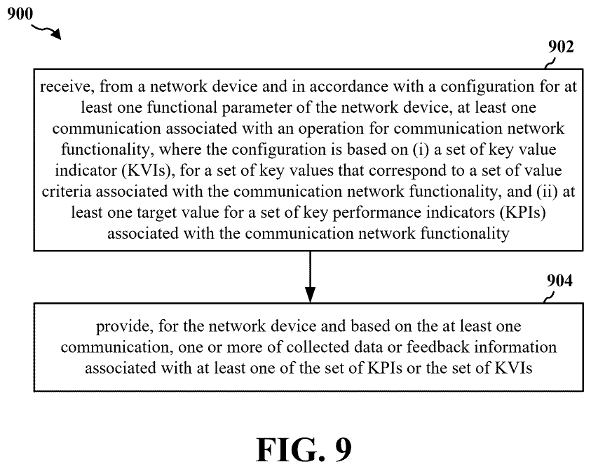

FIG. 9 is a flowchart 900 of a method of wireless communication. The method may be performed by a UE (e.g., the UE 104, 403; the apparatus 1004). In some aspects, the method may include aspects described in connection with the communication flow in FIG. 4 and/or aspects described in FIGS. 5, 6. The method may be for KVI and KPI frameworks. The method may enable continued satisfaction for respective targets on KVIs and KPIs in use cases to promote, improve, and maintain sustainability, e.g., in the contexts of environmental, social, and economic sustainability, and performance together by providing KVI and KPI frameworks for analyzing given use cases with respect to their KVs, KVIs, and KPIs, and may also enable continued tracking and improvements for sustainability considerations, e.g., in the contexts of environmental, social, and economic sustainability, by providing collected data and/or feedback information associated with KVIs/KPIs associated with a network device.

At 902, the UE receives, from a network device and in accordance with a configuration for at least one functional parameter of the network device, at least one communication associated with an operation for communication network functionality, where the configuration is based on (i) a set of key value indicator (KVIs), for a set of key values that correspond to a set of value criteria associated with the communication network functionality, and (ii) at least one target value for a set of key performance indicators (KPIs) associated with the communication network functionality. As an example, the reception may be performed by one or more of the component 198, the transceiver(s) 1022 and/or the antenna 1080 in FIG. 10. FIG. 4 illustrates, in the context of FIGS. 5, 6, an example of the UE 403 receiving such a communication(s) from a network device (e.g., the network device 402).

The UE 403 may be configured to receive, from the network device 402 and in accordance with a configuration 407 (e.g., 536 in FIG. 5; at 636 in FIG. 6) for at least one functional parameter (e.g., of 504 and 518 in FIG. 5; of 604 and 618 in FIG. 6) of the network device 402, at least one communication 410 associated with an operation for communication network functionality, where the configuration 407 (e.g., 536 in FIG. 5; at 636 in FIG. 6) is based on (i) a set of key value indicator (KVIs) (e.g., 590 in FIG. 5; 690 in FIG. 6), for a set of key values (e.g., at 506 in FIG. 5; at 606 in FIG. 6) that correspond to a set of value criteria associated with the communication network functionality, and (ii) at least one target value (e.g., at 512 in FIG. 5; at 612 in FIG. 6) for a set of key performance indicators (KPIs) (e.g., 592 in FIG. 5; 692 in FIG. 6) associated with the communication network functionality.

The network device 402 may be configured to communicate (at 408), based on the configuration 407 (e.g., 536 in FIG. 5; at 636 in FIG. 6) and based on the set of entity KVIs (e.g., 590 in FIG. 5; 690 in FIG. 6) and the set of entity KPIs (e.g., 592 in FIG. 5; 692 in FIG. 6) meeting the condition (e.g., at 522 in FIG. 5; at 622, at 624 in FIG. 6), with a different network device (e.g., the UE 403, the base station 404, the entity/function of the core network 405, and/or the like) in association with at least one operation for the communication network functionality. The network device 402, to communicate (at 408) with the different network device in association with the communication network functionality, may be configured to communicate over at least one of a core network, a RAN, a LAN, or a point-to-point wireless connection. To communicate (at 408) with the different network device in association with the communication network functionality, the network device may be configured to communicate (at 408) based on a software application executed at a UE (e.g., the UE 403). The software application may be associated with the set of key values (e.g., at 506 in FIG. 5; at 606 in FIG. 6), in aspects, and to communicate with the different network device in association with the communication network functionality, the network device 402 may be configured to receive, from the UE 403, one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6).

At 904, the UE provides, for the network device and based on the at least one communication, one or more of collected data or feedback information associated with at least one of the set of KPIs or the set of KVIs. As an example, the provision may be performed by one or more of the component 198, the transceiver(s) 1022 and/or the antenna 1080 in FIG. 10. FIG. 4 illustrates, in the context of FIGS. 5, 6, an example of the UE 403 providing such data/information for a network device (e.g., the network device 402).

The UE 403 may be configured to provide (at 412), and the network device 402 may be configured to receive, based on the at least one communication 410, one or more of collected data or feedback information 414 associated with at least one of the set of KPIs (e.g., 592 in FIG. 5; 692 in FIG. 6) or the set of KVIs (e.g., 590 in FIG. 5; 690 in FIG. 6). In aspects, to receive one or more of the collected data or feedback information 414, the network device 402 may be configured to receive one or more of the collected data or feedback information 414 based on at least one of a reporting periodicity or a reporting content configuration. The UE 403, to receive the at least one communication 410 and/or to provide one or more of the collected data or feedback information 414, may be configured to communicate over at least one of a core network, a RAN, a LAN, or a point-to-point wireless connection. The at least one communication 410 may be indicative of at least one of a reporting periodicity or a reporting content configuration associated with one or more of the collected data or feedback information 414. In aspects, one or more of the collected data or feedback information 414 may correspond to a software application, executed at the UE 403, that is associated with the set of key values (e.g., at 506 in FIG. 5; at 606 in FIG. 6). In aspects, one or more of the collected data or feedback information 414 may be associated with a set of values for at least one of the set of KPIs (e.g., 592 in FIG. 5; 692 in FIG. 6) or the set of KVIs (e.g., 590 in FIG. 5; 690 in FIG. 6).

The UE 403, to provide (at 412) for the network device 402 and based on the at least one communication 410, one or more of the collected data or feedback information 414, may be configured to provide (at 412) one or more of the collected data or feedback information 414 based on at least one of the reporting periodicity or the reporting content configuration. In aspects, the one or more of collected data or feedback information 414 associated with at least one of the set of KPIs or the set of KVIs may be indicative of the network device 402 meeting, or failing to meet, the condition.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The cellular baseband processor(s) 1024 and the application processor(s) 1006 are configured to perform the various functions described supra based at least in part of the information stored in the memory. That is, the cellular baseband processor(s) 1024 and the application processor(s) 1006 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the component 198 may be configured to receive, from a network device and in accordance with a configuration for at least one functional parameter of the network device, at least one communication associated with an operation for communication network functionality, where the configuration is based on (i) a set of KVIs, for a set of key values that correspond to a set of value criteria associated with the communication network functionality, and (ii) at least one target value for a set of KPIs associated with the communication network functionality. The component 198 may also be configured to provide, for the network device and based on the at least one communication, one or more of collected data or feedback information associated with at least one of the set of KPIs or the set of KVIs. As discussed supra, the component 199 may be configured to obtain a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. The component 199 may be configured to communicate, based on the configuration and based on the set of entity KVIs and the set of entity KPIs meeting the condition, with a different network device in association with at least one operation for the communication network functionality. The component 199 may also be configured to adjust the at least one functional parameter of the network device based on at least one of the set of KVIs or the set of KPIs failing to meet the condition. The component 198 and/or the component 199 may be further configured to perform any of the aspects described in connection with the flowcharts in any of FIGS. 7, 8, 9, and/or any of the aspects performed by a UE for any of FIGS. 5, 6. The component 198 and/or the component 199 may be within the cellular baseband processor(s) 1024, the application processor(s) 1006, or both the cellular baseband processor(s) 1024 and the application processor(s) 1006. The component 198 and/or the component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving, from a network device and in accordance with a configuration for at least one functional parameter of the network device, at least one communication associated with an operation for communication network functionality, where the configuration is based on (i) a set of KVIs, for a set of key values that correspond to a set of value criteria associated with the communication network functionality, and (ii) at least one target value for a set of KPIs associated with the communication network functionality. In one configuration, the apparatus 1004, and in particular the cellular baseband processor(s) 1024 and/or the application processor(s) 1006, may include means for providing, for the network device and based on the at least one communication, one or more of collected data or feedback information associated with at least one of the set of KPIs or the set of KVIs. In one configuration, the apparatus 1004, and in particular the cellular baseband processor(s) 1024 and/or the application processor(s) 1006, may include means for obtaining a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. In one configuration, the apparatus 1004, and in particular the cellular baseband processor(s) 1024 and/or the application processor(s) 1006, may include means for communicating, based on the configuration and based on the set of entity KVIs and the set of entity KPIs meeting the condition, with a different network device in association with at least one operation for the communication network functionality. In one configuration, the apparatus 1004, and in particular the cellular baseband processor(s) 1024 and/or the application processor(s) 1006, may include means for adjusting the at least one functional parameter of the network device based on at least one of the set of KVIs or the set of KPIs failing to meet the condition. The means may be the component 198 and/or the component 199 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to may be configured to obtain a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. The component 199 may be configured to communicate, based on the configuration and based on the set of entity KVIs and the set of entity KPIs meeting the condition, with a different network device in association with at least one operation for the communication network functionality. The component 199 may also be configured to adjust the at least one functional parameter of the network device based on at least one of the set of KVIs or the set of KPIs failing to meet the condition. The component 199 may be further configured to perform any of the aspects described in connection with the flowcharts in any of FIGS. 7, 8, 9, and/or any of the aspects performed by a network device for any of FIGS. 5, 6. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for obtaining a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. In one configuration, the network entity 1102 may include means for communicating, based on the configuration and based on the set of entity KVIs and the set of entity KPIs meeting the condition, with a different network device in association with at least one operation for the communication network functionality. In one configuration, the network entity 1102 may include means for adjusting the at least one functional parameter of the network device based on at least one of the set of KVIs or the set of KPIs failing to meet the condition. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 12 is a diagram 1200 illustrating an example of a hardware implementation for a network entity 1260. In one example, the network entity 1260 may be within the core network 120. The network entity 1260 may include at least one network processor 1212. The network processor(s) 1212 may include on-chip memory 1212′. In some aspects, the network entity 1260 may further include additional memory modules 1214. The network entity 1260 communicates via the network interface 1280 directly (e.g., backhaul link) or indirectly (e.g., through a RIC) with the CU 1202 and/or the UE 104. The on-chip memory 1212′ and the additional memory modules 1214 may each be considered a computer-readable medium/memory. Each computer-readable medium/memory may be non-transitory. The network processor(s) 1212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to may be configured to obtain a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. The component 199 may be configured to communicate, based on the configuration and based on the set of entity KVIs and the set of entity KPIs meeting the condition, with a different network device in association with at least one operation for the communication network functionality. The component 199 may also be configured to adjust the at least one functional parameter of the network device based on at least one of the set of KVIs or the set of KPIs failing to meet the condition. The component 199 may be further configured to perform any of the aspects described in connection with the flowcharts in any of FIGS. 7, 8, 9, and/or any of the aspects performed by a network device for any of FIGS. 5, 6. The component 199 may be within the network processor(s) 1212. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1260 may include a variety of components configured for various functions. In one configuration, the network entity 1260 may include means for obtaining a configuration for at least one functional parameter that is based on (i) a set of KVIs, for a set of key values that correspond to a set of value criteria associated with communication network functionality, and (ii) at least one target value for a set of KPIs associated with the communication network functionality, where the configuration is indicative of (i) a set of entity KVIs, for the network device, associated with the set of KVIs and (ii) a set of entity KPIs, for the network device, associated with the set of KPIs, and where characteristics of the network device, jointly for the set of entity KVIs and the set of entity KPIs, are indicative of meeting a condition associated with the set of value criteria for the communication network functionality. In one configuration, the network entity 1260 may include means for communicating, based on the configuration and based on the set of entity KVIs and the set of entity KPIs meeting the condition, with a different network device in association with at least one operation for the communication network functionality. In one configuration, the network entity 1260 may include means for adjusting the at least one functional parameter of the network device based on at least one of the set of KVIs or the set of KPIs failing to meet the condition. The means may be the component 199 of the network entity 1260 configured to perform the functions recited by the means.

Some wireless communication systems (such as a 5G system (or another type of system described herein, or advanced systems such as 5G derivatives, 6G, etc.)) may use KPIs to quantitively measure or track key performance for technical parameters and/or metrics during operation of network devices and services. However, sustainability in the contexts of environmental, social, and economic sustainability, wireless communication systems (such as a 5G system (or another type of system described herein, or advanced systems such as 5G derivatives, 6G, etc.)) may have relatively few considerations or expectations. For example, minimizations for usage footprints (e.g., negative impacts) of wireless communication systems, including future generations such as 6G, etc., may enable positive impacts and risk avoidance in other sectors induced from various use cases.

Aspects presented herein provide a framework that may be used to analyze a given use case with respect to its key values (KVs), KVIs, and KPIs to ensure that a use case is able to satisfy respective targets on KVIs and KPIs during its usage lifetime.

Aspects herein for communication network functionality with KVI and KPI frameworks improve on the issues noted above. A network device (e.g., a UE, a gNB, a core network function/entity, and/or the like) may obtain a configuration for at least one functional parameter thereof. The configuration may be based on (i) a set of KVIs, for a set of key values that correspond to a set of value criteria associated with communication network functionality, and on (ii) at least one target value for a set of KPIs associated with the communication network functionality. That is, aspects account for a framework that considers criteria for both KVIs and KPIs. The configuration may be indicative of a set of entity KVIs, for a network device, associated with the set of KVIs and of a set of entity KPIs, for the network device, associated with the set of KPIs. Characteristics of the network device, e.g., jointly, e.g., for both, the set of entity KVIs and the set of entity KPIs, may be indicative of meeting a condition associated with the set of value criteria for the communication network functionality, and such a condition may be based on sustainability, e.g., in the contexts of environmental, social, and economic sustainability. The network device may thus be configured to communicate, based on the configuration and based on the set of entity KVIs and the set of entity KPIs meeting the condition, with other network devices in association with at least one operation for the communication network functionality. Additionally, a UE, a gNB, etc., may receive, from a network device and in accordance with such a configuration for at least one functional parameter of the network device, at least one communication associated with an operation for the communication network functionality. The UE, gNB, etc., may provide collected data and/or feedback information associated with at least one of the set of KPIs or the set of KVIs for the network device. Accordingly, aspects enable continued satisfaction for respective targets on KVIs and KPIs in use cases to promote, improve, and maintain sustainability, e.g., in the contexts of environmental, social, and economic sustainability, and performance together by providing KVI and KPI frameworks for analyzing given use cases with respect to their KVs, KVIs, and KPIs, and also enable continued tracking and improvements for sustainability considerations, e.g., in the contexts of environmental, social, and economic sustainability, by providing collected data and/or feedback information associated with KVIs/KPIs associated with a network device.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network device, comprising: obtaining a configuration for at least one functional parameter that is based on (i) a set of key value indicator (KVIs), for a set of key values that correspond to a set of value criteria associated with communication network functionality, and (ii) at least one target value for a set of key performance indicators (KPIs) associated with the communication network functionality, wherein the configuration is indicative of (i) a set of entity KVIs, for the network device, associated with the set of KVIs and (ii) a set of entity KPIs, for the network device, associated with the set of KPIs, and wherein characteristics of the network device, jointly for the set of entity KVIs and the set of entity KPIs, are indicative of meeting a condition associated with the set of value criteria for the communication network functionality; and communicating, based on the configuration and based on the set of entity KVIs and the set of entity KPIs meeting the condition, with a different network device in association with at least one operation for the communication network functionality.

Aspect 2 is the method of aspect 1, where the at least one processor is further configured to: adjust the at least one functional parameter of the network device based on at least one of the set of KVIs or the set of KPIs failing to meet the condition.

Aspect 3 is the method of aspect 2, wherein to adjust the at least one functional parameter, the at least one processor is configured to at least one of: adjust the at least one functional parameter prior to the at least one operation; or communicate, as a portion of the at least one operation, with at least one of a user equipment (UE) or a base station, and receive, from at least one of the UE or the base station, one or more of collected data or feedback information associated with at least one of the set of KPIs or the set of KVIs.

Aspect 4 is the method of aspect 3, wherein to receive one or more of the collected data or the feedback information, the at least one processor is configured to receive one or more of the collected data or the feedback information based on at least one of a reporting periodicity or a reporting content configuration.

Aspect 5 is the method of any of aspects 3 and 4, wherein to adjust the at least one functional parameter, the at least one processor is configured to adjust the at least one functional parameter, based on at least one of (i) a set of iterations or (ii) a machine learning (AI)/artificial intelligence (ML) (AI/ML) model associated with KVI and KPI training sets, for changes to one or more of the set of KVIs or the set of KPIs until the set of KVIs and the set of KPIs jointly meet the condition together.

Aspect 6 is the method of any of aspects 3 to 5, wherein the condition comprises a KPI condition and a KVI condition, wherein to adjust the at least one functional parameter the at least one processor is configured to adjust the at least one functional parameter, based on at least one of (i) a set of iterations or (ii) a machine learning (AI)/artificial intelligence (ML) (AI/ML) model associated with KVI and KPI training sets, for changes to one or more of the set of KVIs or the set of KPIs until separately the set of KVIs meets the KVI condition and the set of KPIs meet the KPI condition.

Aspect 7 is the method of any of aspects 1 to 6, wherein the set of key values includes at least one of a set of economic criteria, a set of social criteria, or a set of environmental criteria, wherein the set of KVIs are indicative of quantified or qualified effects that correspond to the set of key values.

Aspect 8 is the method of aspect 7, wherein the set of KVIs includes at least one implementation KVI associated with an improvement effect for the set of key values.

Aspect 9 is the method of any of aspects 1 to 6, wherein the set of KPIs includes at least one measurement of performance for a communication network.

Aspect 10 is the method of aspect 9, wherein the at least one measurement is associated with one or more of a network coverage, a signal-to-noise ratio (SNR), a signal to interference and noise ratio (SINR), a mobility metric, a power consumption, a network throughput, or a network latency.

Aspect 11 is the method of any of aspects 1 to 10, wherein the network device, jointly for the set of entity KVIs and the set of entity KPIs, meets the condition associated with the set of value criteria for the communication network functionality based on a condition determination of both of the set of entity KVIs and the set of entity KPIs together.

Aspect 12 is the method of any of aspects 1 to 10, wherein the condition comprises a KPI condition and a KVI condition, wherein the network device, meets the KVI condition for the set of entity KVIs and separately meets the KPI condition for the set of entity KPIs, in association with the set of value criteria for the communication network functionality based on a condition determination of both of the set of entity KVIs and the set of entity KPIs separately.

Aspect 13 is the method of any of aspects 1 to 12, wherein to obtain the configuration, the at least one processor is configured to receive the configuration in accordance with a selection of the network device, from a set of network devices, that is based on the network device meeting the condition.

Aspect 14 is the method of any of aspects 1 to 13, wherein the network device is at least one of a user equipment (UE), a base station, a transmission reception point (TRP), an access point (AP), a reflecting intelligent surface (RIS), an access and mobility management function (AMF), a location management function (LMF), or a sessions management function (SMF).

Aspect 15 is the method of any of aspects 1 to 14, wherein to communicate with the different network device in association with the communication network functionality, the at least one processor may be configured to communicate over at least one of a core network, a radio access network (RAN), a local access network (LAN), or a point-to-point wireless connection.

Aspect 16 is the method of aspect 15, wherein to communicate with the different network device in association with the communication network functionality, the at least one processor is configured to communicate based on a software application executed at a user equipment (UE), wherein the software application is associated with the set of key values, and wherein to communicate with the different network device in association with the communication network functionality, the at least one processor may be configured to receive, from the UE, one or more of collected data or feedback information associated with at least one of the set of KPIs or the set of KVIs.

Aspect 17 is the method of any of aspects 1 to 16, wherein the communication network functionality includes non-communicative operations at the network device.

Aspect 18 is a method of wireless communication at a user equipment (UE), comprising: receiving, from a network device and in accordance with a configuration for at least one functional parameter of the network device, at least one communication associated with an operation for communication network functionality, wherein the configuration is based on (i) a set of key value indicator (KVIs), for a set of key values that correspond to a set of value criteria associated with the communication network functionality, and (ii) at least one target value for a set of key performance indicators (KPIs) associated with the communication network functionality; and providing, for the network device and based on the at least one communication, one or more of collected data or feedback information associated with at least one of the set of KPIs or the set of KVIs.

Aspect 20 is the method of aspect 19, wherein one or more of the collected data or the feedback information corresponds to a software application, executed at the UE, that is associated with the set of key values; or wherein one or more of the collected data or the feedback information is associated with a set of values for at least one of the set of KPIs or the set of KVIs.

Aspect 21 is the method of any of aspects 19 and 20, wherein the at least one communication is indicative of at least one of a reporting periodicity or a reporting content configuration associated with one or more of the collected data or the feedback information; wherein to provide, for the network device and based on the at least one communication, one or more of the collected data or the feedback information, the at least one processor is configured to provide one or more of the collected data or the feedback information based on at least one of the reporting periodicity or the reporting content configuration.

Aspect 22 is the method of any of aspects 19 to 21, wherein the network device is at least one of a different UE, a base station, a transmission reception point (TRP), an access point (AP), a reflecting intelligent surface (RIS), an access and mobility management function (AMF), a location management function (LMF), or a sessions management function (SMF).

Aspect 23 is the method of any of aspects 19 to 22, wherein to receive the at least one communication or providing one or more of the collected data or the feedback information, the at least one processor is configured to communicate over at least one of a core network, a radio access network (RAN), a local access network (LAN), or a point-to-point wireless connection.

Aspect 24 is the method of any of aspects 19 to 23, wherein the set of key values includes at least one of a set of economic criteria, a set of social criteria, or a set of environmental criteria, wherein the set of KVIs are indicative of quantified or qualified effects that correspond to the set of key values.

Aspect 25 is the method of aspect 24, wherein the set of KVIs includes at least one implementation KVI associated with an improvement effect for the set of key values.

Aspect 26 is the method of any of aspects 19 to 25, wherein the set of KPIs includes at least one measurement of performance for a communication network.

Aspect 27 is the method of aspect 26, wherein the at least one measurement is associated with one or more of a network coverage, a signal-to-noise ratio (SNR), a signal to interference and noise ratio (SINR), a mobility metric, a power consumption, a network throughput, or a network latency.

Aspect 28 is an apparatus for wireless communication at a network device, comprising: at least one memory; and at least one processor coupled to the at least one memory, the at least one processor is configured to perform the method of any of aspects 1 to 17.

Aspect 29 is an apparatus for wireless communication at a network device, comprising means for performing each step in the method of any of aspects 1 to 17.

Aspect 30 is the apparatus of any of aspects 28 to 30, further comprising a transceiver configured to receive or to transmit in association with the method of any of aspects 1 to 17.

Aspect 31 is a computer-readable medium storing computer executable code at a network device, the code when executed by at least one processor causes the at least one processor to perform the method of any of aspects 1 to 17.

Aspect 32 is an apparatus for wireless communication at a user equipment (UE), comprising: at least one memory; and at least one processor coupled to the at least one memory, the at least one processor is configured to perform the method of any of aspects 18 to 27.

Aspect 33 is an apparatus for wireless communication at a user equipment (UE), comprising means for performing each step in the method of any of aspects 18 to 27.

Aspect 34 is the apparatus of any of aspects 32 to 33, further comprising a transceiver configured to receive or to transmit in association with the method of any of aspects 18 to 27.

Aspect 35 is a computer-readable medium storing computer executable code at a user equipment (UE), the code when executed by at least one processor causes the at least one processor to perform the method of any of aspects 18 to 27.

What is claimed is:

1. An apparatus for wireless communication at a network device, comprising:
at least one memory; and
at least one processor coupled to the at least one memory and, based at least in part on information stored in the at least one memory, the at least one processor is configured to:
obtain a configuration for at least one functional parameter that is based on (i) a set of key value indicator (KVIs), for a set of key values that correspond to a set of value criteria associated with communication network functionality, and (ii) at least one target value for a set of key performance indicators (KPIs) associated with the communication network functionality,
wherein the configuration is indicative of (i) a set of entity KVIs, for the network device, associated with the set of KVIs and (ii) a set of entity KPIs, for the network device, associated with the set of KPIs, and
wherein characteristics of the network device, jointly for the set of entity KVIs and the set of entity KPIs, are indicative of meeting a condition associated with the set of value criteria for the communication network functionality; and
communicate, based on the configuration and based on the set of entity KVIs and the set of entity KPIs meeting the condition, with a different network device in association with at least one operation for the communication network functionality.

2. The apparatus of claim 1, where the at least one processor is further configured to:
adjust the at least one functional parameter of the network device based on at least one of the set of KVIs or the set of KPIs failing to meet the condition.

3. The apparatus of claim 2, wherein to adjust the at least one functional parameter, the at least one processor is configured to at least one of:
adjust the at least one functional parameter prior to the at least one operation; or
communicate, as a portion of the at least one operation, with at least one of a user equipment (UE) or a base station, and receive, from at least one of the UE or the base station, one or more of collected data or feedback information associated with at least one of the set of KPIs or the set of KVIs.

4. The apparatus of claim 3, wherein to receive one or more of the collected data or the feedback information, the at least one processor is configured to receive one or more of the collected data or the feedback information based on at least one of a reporting periodicity or a reporting content configuration.

5. The apparatus of claim 3, wherein to adjust the at least one functional parameter, the at least one processor is configured to adjust the at least one functional parameter, based on at least one of (i) a set of iterations or (ii) a machine learning (AI)/artificial intelligence (ML) (AI/ML) model associated with KVI and KPI training sets, for changes to one or more of the set of KVIs or the set of KPIs until the set of KVIs and the set of KPIs jointly meet the condition together.

6. The apparatus of claim 3, wherein the condition comprises a KPI condition and a KVI condition, wherein to adjust the at least one functional parameter the at least one processor is configured to adjust the at least one functional parameter, based on at least one of (i) a set of iterations or (ii) a machine learning (AI)/artificial intelligence (ML) (AI/ML) model associated with KVI and KPI training sets, for changes to one or more of the set of KVIs or the set of KPIs until separately the set of KVIs meets the KVI condition and the set of KPIs meet the KPI condition.

7. The apparatus of claim 1, wherein the set of key values includes at least one of a set of economic criteria, a set of social criteria, or a set of environmental criteria, wherein the set of KVIs are indicative of quantified or qualified effects that correspond to the set of key values.

8. The apparatus of claim 7, wherein the set of KVIs includes at least one implementation KVI associated with an improvement effect for the set of key values.

9. The apparatus of claim 1, wherein the set of KPIs includes at least one measurement of performance for a communication network.

10. The apparatus of claim 9, wherein the at least one measurement is associated with one or more of a network coverage, a signal-to-noise ratio (SNR), a signal to interference and noise ratio (SINR), a mobility metric, a power consumption, a network throughput, or a network latency.

11. The apparatus of claim 1, wherein the network device, jointly for the set of entity KVIs and the set of entity KPIs, meets the condition associated with the set of value criteria for the communication network functionality based on a condition determination of both of the set of entity KVIs and the set of entity KPIs together.

12. The apparatus of claim 1, wherein the condition comprises a KPI condition and a KVI condition, wherein the network device, meets the KVI condition for the set of entity KVIs and separately meets the KPI condition for the set of entity KPIs, in association with the set of value criteria for the communication network functionality based on a condition determination of both of the set of entity KVIs and the set of entity KPIs separately.

13. The apparatus of claim 1, wherein to obtain the configuration, the at least one processor is configured to receive the configuration in accordance with a selection of the network device, from a set of network devices, that is based on the network device meeting the condition.

14. The apparatus of claim 1, wherein the network device is at least one of a user equipment (UE), a base station, a transmission reception point (TRP), an access point (AP), a reflecting intelligent surface (RIS), an access and mobility management function (AMF), a location management function (LMF), or a sessions management function (SMF).

15. The apparatus of claim 1, wherein to communicate with the different network device in association with the communication network functionality, the at least one processor may be configured to communicate over at least one of a core network, a radio access network (RAN), a local access network (LAN), or a point-to-point wireless connection.

16. The apparatus of claim 15, wherein to communicate with the different network device in association with the communication network functionality, the at least one processor is configured to communicate based on a software application executed at a user equipment (UE),
wherein the software application is associated with the set of key values, and
wherein to communicate with the different network device in association with the communication network functionality, the at least one processor may be configured to receive, from the UE, one or more of collected data or feedback information associated with at least one of the set of KPIs or the set of KVIs.

17. The apparatus of claim 1, wherein the communication network functionality includes non-communicative operations at the network device.

18. The apparatus of claim 1, further comprising at least one transceiver coupled to the at least one processor, wherein to communicate with the different network device, the at least one processor is configured to communicate, via the at least one transceiver, with the different network device.

19. An apparatus for wireless communication at a user equipment (UE), comprising:
at least one memory; and
at least one processor coupled to the at least one memory and, based at least in part on information stored in the at least one memory, the at least one processor is configured to:
receive, from a network device and in accordance with a configuration for at least one functional parameter of the network device, at least one communication associated with an operation for communication network functionality, wherein the configuration is based on (i) a set of key value indicator (KVIs), for a set of key values that correspond to a set of value criteria associated with the communication network functionality, and (ii) at least one target value for a set of key performance indicators (KPIs) associated with the communication network functionality; and
provide, for the network device and based on the at least one communication, one or more of collected data or feedback information associated with at least one of the set of KPIs or the set of KVIs.

20. The apparatus of claim 19, wherein one or more of the collected data or the feedback information corresponds to a software application, executed at the UE, that is associated with the set of key values; or
wherein one or more of the collected data or the feedback information is associated with a set of values for at least one of the set of KPIs or the set of KVIs.

21. The apparatus of claim 19, wherein the at least one communication is indicative of at least one of a reporting periodicity or a reporting content configuration associated with one or more of the collected data or the feedback information;
wherein to provide, for the network device and based on the at least one communication, one or more of the collected data or the feedback information, the at least one processor is configured to provide one or more of the collected data or the feedback information based on at least one of the reporting periodicity or the reporting content configuration.

22. The apparatus of claim 19, wherein the network device is at least one of a different UE, a base station, a transmission reception point (TRP), an access point (AP), a reflecting intelligent surface (RIS), an access and mobility management function (AMF), a location management function (LMF), or a sessions management function (SMF).

23. The apparatus of claim 19, wherein to receive the at least one communication or providing one or more of the collected data or the feedback information, the at least one processor is configured to communicate over at least one of a core network, a radio access network (RAN), a local access network (LAN), or a point-to-point wireless connection.

24. The apparatus of claim 19, wherein the set of key values includes at least one of a set of economic criteria, a set of social criteria, or a set of environmental criteria, wherein the set of KVIs are indicative of quantified or qualified effects that correspond to the set of key values.

25. The apparatus of claim 24, wherein the set of KVIs includes at least one implementation KVI associated with an improvement effect for the set of key values.

26. The apparatus of claim 19, wherein the set of KPIs includes at least one measurement of performance for a communication network.

27. The apparatus of claim 26, wherein the at least one measurement is associated with one or more of a network coverage, a signal-to-noise ratio (SNR), a signal to interference and noise ratio (SINR), a mobility metric, a power consumption, a network throughput, or a network latency.

28. The apparatus of claim 19, further comprising at least one transceiver coupled to the at least one processor, wherein to receive the at least one communication or to provide one or more of the collected data or the feedback information, the at least one processor is configured to communicate, via the at least one transceiver, with the network device.

29. A method of wireless communication at a network device, comprising:
obtaining a configuration for at least one functional parameter that is based on (i) a set of key value indicator (KVIs), for a set of key values that correspond to a set of value criteria associated with communication network functionality, and (ii) at least one target value for a set of key performance indicators (KPIs) associated with the communication network functionality,
wherein the configuration is indicative of (i) a set of entity KVIs, for the network device, associated with the set of KVIs and (ii) a set of entity KPIs, for the network device, associated with the set of KPIs, and
wherein characteristics of the network device, jointly for the set of entity KVIs and the set of entity KPIs, are indicative of meeting a condition associated with the set of value criteria for the communication network functionality; and
communicating, based on the configuration and based on the set of entity KVIs and the set of entity KPIs meeting the condition, with a different network device in association with at least one operation for the communication network functionality.

30. A method of wireless communication at a user equipment (UE), comprising:
receiving, from a network device and in accordance with a configuration for at least one functional parameter of the network device, at least one communication associated with an operation for communication network functionality, wherein the configuration is based on (i) a set of key value indicator (KVIs), for a set of key values that correspond to a set of value criteria associated with the communication network functionality, and (ii) at least one target value for a set of key performance indicators (KPIs) associated with the communication network functionality; and
providing, for the network device and based on the at least one communication, one or more of collected data or feedback information associated with at least one of the set of KPIs or the set of KVIs.
